(19) United States
(12) Patent Application Publication
(10) Pub. No.: US 2008/0170294 A1
(43) Pub. Date: Jul. 17, 2008

(54) RETARDATION FILM AND POLARIZING PLATE

(76) Inventors: Takashi KURODA, Tokyo-to (JP); Runa NAKAMURA, Tokyo-to (JP); Hiroki NAKAGAWA, Tokyo-to (JP); Yuya INOMATA, Tokyo-to (JP); Masanori FUKUDA, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/872,903

(22) Filed: Oct. 16, 2007

(30) Foreign Application Priority Data
Oct. 16, 2006 (JP) 2006-281987
Oct. 16, 2006 (JP) 2006-281989
Dec. 6, 2006 (JP) 2006-329706
Jul. 18, 2007 (JP) 2007-187461

(51) Int. Cl. G02B 5/30

(52) U.S. Cl. 359/500

(57) ABSTRACT

A retardation film having excellent optical characteristic realizing properties, which is capable of obtaining a highly durable polarizing plate having a viewing angle compensating function by being used as a polarizing plate protection film. The retardation film can be used as a viewing angle compensating film of a liquid crystal display of the IPS system, with a wide realizable range of optical characteristics, excellent adhesion properties to a polarizer, and the adjustment easiness of the optical characteristics. The retardation film has an optically anisotropic film, an optically anisotropic layer, and a first optically anisotropic material showing a positive dispersion type wavelength dependency of a retardation, in which a refractive index nx₁ of a lagging phase axis direction in an in-plane direction and a refractive index ny₁ of a leading phase axis direction in the in-plane direction satisfy the formula of nx₁>ny₁.

### BACKGROUND OF THE INVENTION

1. Field of the Invention

The present invention relates to a retardation film to be used preferably for the liquid crystal display of the IPS system and a polarizing plate.

2. Description of the Related Art

Owing to the characteristics of such as power saving, lightweight and thin shape, the liquid crystal displays have recently been spread at a high rate instead of the conventional CRT displays. As a common liquid crystal display, one comprising an incident side polarizing plate 102A, an output side polarizing plate 102B and a liquid crystal cell 101 as shown in FIG. 10 can be presented. The polarizing plates 102A and 102B are provided for selectively transmitting only a linear polarization having an oscillation plane in a predetermined oscillation direction, disposed in a crossed Nicol state with their oscillation directions perpendicular with each other. Moreover, the liquid crystal cell 101 including a large number of cells corresponding to the pixels is disposed between the polarizing plates 102A and 102B.

As the liquid crystal displays, those of various systems have been put into practice according to the alignment form of the liquid crystal molecules comprising the liquid crystal cell. Those used widely as the main stream of the liquid crystal displays nowadays can be classified into such as the TN, STN, MVA, IPS, and OCB. In particular, currently, those of the MVA and IPS driving systems are broadly employed.

On the other hand, as the problem unique to the liquid crystal displays, the problem of the viewing angle dependency derived from the refractive index anisotropic properties of the liquid crystal cell or the polarizing plate can be presented. According to the problem of the viewing angle dependency, the tinge and the contrast of the image to be visually recognized vary between the case when the liquid crystal displays is viewed from the front side and the case when viewed from the oblique direction. The issue of the viewing angle characteristics is more and more regarded seriously according to the recent trend in providing larger-screen liquid crystal displays.

In order to solve the problem of the viewing angle dependency, various techniques have been developed so far. As a representative method thereof, a method of using a retardation film can be presented. According to the method of using a retardation film, as shown in FIG. 11, by disposing a retardation film 103 having a predetermined optical characteristics (refractive index anisotropic properties) at least either between a liquid crystal cell 101 and a polarizing plate 102A, or between the liquid crystal cell 101 and a polarizing plate 102B, the refractive index anisotropic properties of the liquid crystal cell and the refractive index anisotropic properties of the retardation film are offset so as to solve the problem of the viewing angle dependency. In FIG. 11, an embodiment with the liquid crystal cell 101 sandwiched between retardation films 103 is shown as a representative example. Since the above-mentioned problem of the viewing angle dependency can be solved by only assembling the retardation film 103 in the liquid crystal display by the method, it is used widely as a method capable of easily obtaining a liquid crystal display having excellent viewing angle characteristics.

Here, as the retardation film, for example, one having the configuration with a retardation layer containing a regularly aligned liquid crystal material formed on a transparent substrate, and one made of a drawn film are commonly known.

Moreover, recently, instead of the system with the retardation film and the polarizing plate disposed independently as shown in FIG. 11, a system with the retardation film used also as a polarizing plate protection film comprising the polarizing plate has been the mainstream. That is, as shown in FIGS. 12A and 12B, in a common liquid crystal display having a configuration with the polarizing plates 102A and 102B disposed on the both sides of the liquid crystal cell 101, the polarizing plates 102A and 102B in general have the configuration with the polarizer 111 sandwiched by two polarizing plate protection films 112a and 112b (FIG. 12A) (Here for the explanation convenience, the polarizing plate protection film 112a disposed on the liquid crystal cell 101 side is referred to as the “inner side polarizing plate protection film”, and the other polarizing plate protection film 112B is referred to as the “outer side polarizing plate protection film”). Then, in the case of improving the viewing angle characteristics of the liquid crystal display using the retardation film 103, as shown in FIG. 12B, use of the polarizing plates 102A′ and 102B′, in which the retardation film 103 is used, as the inner side polarizing plate protection film 112a out of the two polarizing plate protection films 112a and 112b has been the recent mainstream.

Here, as the polarizing plate protection film to be used for the polarizing plate, those made of a cellulose derivative represented by cellulose triacetate and those made of a cycloolefin resin represented by a norbornen resin are known. Since the cellulose derivative has the excellent water permeability, it is advantageous in that the moisture content contained in the polarizer in the production process of the polarizing plate can be evaporated through the film. However, on the other hand, it is disadvantageous in that the size change and the optical characteristic fluctuation by the moisture absorption are relatively large in the high temperature and high humidity atmosphere. Furthermore, a polarizing plate protection film made of the cellulose derivative has poor gas barrier properties. Therefore, in the case a polarizing plate protection film made of the cellulose derivative is used on the both sides, the optical characteristic endurance of the polarizing plate is lowered, and thus it is problematic. Moreover, a polarizing plate protection film made of the cellulose derivative involves a problem in that the low surface endurance such as the water resistance, the pollution resistance and the friction resistance.

On the other hand, since the cycloolefin resin is a hydrophobic resin, it is advantageous in that the size change and the optical characteristic fluctuation by the moisture absorption are relatively small in the high temperature and high humidity atmosphere, and furthermore, it has the excellent surface endurance. However, on the other hand, it is disadvantageous in that the moisture content contained in the polarizer in the production process of the polarizing plate cannot be evaporated through the film. Therefore, use of a polarizing plate protection film made of the cycloolefin resin on the both sides involves a problem in that the polarizing characteristics are lowered according to passage of the time.

In viewing the above, as the polarizing plate, it is preferable to use: a polarizing plate protection film comprising a polarizing plate protection film made of the cellulose derivative having an excellent water permeability as the inner side polarizing plate protection film which does not require the surface endurance, and a polarizing plate protection film made of the cycloolefin resin having an excellent surface endurance as the outer side polarizing plate protection film for obtaining a polarizing plate with an excellent endurance provided with the advantages of the both resins while offsetting the disadvantages thereof (for example, the official gazette of the Japanese Patent No. 3,132,122). Therefore, as the retardation film, one using a substrate made of the cellulose derivative is regarded as preferable.

The retardation properties of the retardation film depend on factors such as the driving system of the liquid crystal display to be the subject of improvement of the viewing angle characteristics. In particular, according to a liquid crystal display of the IPS (In-Plane Switching) system, it is preferable to use a retardation film having a predetermined retardation properties with properties as a positive C plate and properties as an A plate. In this regard, the official gazettes of the Japanese Patent Application Laid-Open Nos. 2002-174725, 2003-121853 and 2005-70098 disclose a retardation film to be used for such a liquid crystal display of the IPS system having the configuration with a retardation layer of properties as a positive C plate formed on a transparent substrate made of the cycloolefin resin. Since a retardation film having the configuration as disclosed in the above-mentioned three patent documents employs a transparent substrate made of the cycloolefin resin having low moisture absorption properties, it is advantageous in that the risk of the moisture absorption expansion is low even in the high temperature and high humidity atmosphere, and furthermore, the optical characteristic endurance is preferable. However, in general, it is necessary to use the retardation film as the inner side polarizing plate protection film so as to be protected from the outside. As a result, in the case a retardation film using a transparent substrate made of such a cycloolefin resin is used as the inner side polarizing plate protection film mentioned above, a polarizing plate protection film made of a cellulose derivative with the poor surface endurance should be used as the outer side polarizing plate protection film, a problem arises in that the preferable use-embodiment of the polarizing plate described above cannot be realized.

Moreover, the official gazettes of the Japanese Patent Application Laid-Open Nos. 2006-71963, 2006-71964, 2006-71965 and 2006-71966 disclose a polarizing plate integrated type optical compensation film with a film having properties as a positive C plate, a film having properties as an A plate and a polarizing film laminated, wherein either the film having the properties as a positive C plate or the film having the properties as an A plate is made of cellulose propionate. According to the polarizing plate integrated type optical compensating film, since a film made of a cellulose derivative is used, it can be used for the inner side polarizing plate protection film. Therefore, it is preferable in that the problems can be solved. However, since both the film having the properties as a positive C plate and the film having the properties as an A plate are adjusted by containing an optical characteristic realizing agent in the film, a problem is involved in that the optical characteristics are realized poorly. Moreover, due to problems of the film strength deterioration, the film formation property deterioration, and bleeding out of the optical characteristic realizing agent, the amount of the optical characteristic realizing agent to be contained in the film is limited. Consequently, according to a polarizing plate integrated type optical compensating film having the above-mentioned configuration, a problem arises in that the realizable range of the optical characteristics is narrowed. Furthermore, since the optical characteristic realizing agent is in general hydrophobic, if such an optical characteristic realizing agent is contained in the film, at the time of attaching the film with a polarizing film made of a hydrophilic resin such as a polyvinyl alcohol, the adhesion properties is lowered, and thus it is problematic.

Therefore, conventionally, it has been difficult to obtain a retardation film: which can be used preferably as a viewing angle compensating film of a liquid crystal display of the IPS system, with a wide range of the realizable optical characteristics, with the excellent adhesion properties to a polarizer, and with the adjustment easiness of the optical characteristics.

### SUMMARY OF THE INVENTION

The present invention has been achieved in view of the problems, and the main object thereof is to provide a retardation film having the excellent optical characteristic realizing properties, capable of obtaining a highly durable polarizing plate having a viewing angle compensating function by being used as a polarizing plate protection film, and to provide a retardation film to be used preferably as a viewing angle compensating film of a liquid crystal display of the IPS system, with a wide realizable range of the optical characteristics, the excellent adhesion properties to a polarizer, and the adjustment easiness of the optical characteristics.

To attain the object, the present invention provides a retardation film comprising: an optically anisotropic film having; a transparent substrate made of a cellulose derivative, and an optically anisotropic layer, formed on the transparent substrate, containing the cellulose derivative for comprising the transparent substrate, and a first optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and a retardation layer, formed on the optically anisotropic film, containing a second optically anisotropic material showing a normal dispersion type wavelength dependency, in which refractive indices nx₂ and ny₂ of optional x and y directions orthogonal with each other in the in-plane direction and a refractive index nz₂ of a thickness direction satisfy the formula of nx₂≦ny₂<nz₂, wherein the first optically anisotropic material comprises a compound made of a polymerizable rodlike molecule having a structure with a polymerizable functional group and a mesogenic group bonded via an alkyl chain having 4 or more carbon atoms.

According to the present invention, since the first optically anisotropic material includes a compound made of a polymerizable rodlike molecule having a structure with a polymerizable functional group and a mesogenic group bonded via an alkyl chain having 4 or more carbon atoms, the first optically anisotropic layer can be provided with excellent optical anisotropy (nx₁>ny₁) realizing properties. Therefore, according to the present invention, for example, the high optical anisotropy can be realized with an optically anisotropic layer of a thin thickness, a retardation film having excellent optical characteristic realizing properties can be obtained.

Moreover, according to the present invention, since a transparent substrate made of a cellulose derivative is used for the optically anisotropic film, in the case of using a retardation film of the present invention as the inner side polarizing plate protection film for protecting the retardation film from the outside, the polarizing plate protection film has the water permeability so that the moisture content of the polarizer can be eliminated at the time of producing the polarizing plate. As a result, a polarizing plate protection film made of a cycloolefin resin having excellent surface endurance, in which even without the moisture permeability, can be used as the outer side polarizing plate protection film. Therefore, a polarizing plate with excellent endurance can be obtained.

Furthermore, according to the present invention, since the retardation layer has the optical characteristics satisfying the formula of nx≦ny<nz and the optically anisotropic film has the optical characteristics satisfying the formula of nx>ny, by using the retardation film of the present invention for the polarizing plate protection film, a polarizing plate having the viewing angle compensating function of the liquid crystal display of the IPS system can be obtained.

Accordingly, in the present invention, a highly durable polarizing plate having the viewing angle compensating function by being used as the polarizing plate protection film can be provided and a retardation film having excellent optical characteristic realizing properties can be obtained.

In the present invention, it is preferable that the compound made of a polymerizable rod like molecule in the first optically anisotropic material is a monofunctional polymerizable liquid crystal compound having a single polymerizable functional group in the molecule. Since the polymerizable liquid crystal compound is such a monofunctional polymerizable liquid crystal compound, the optical anisotrop realizing properties of the optically an isotropic layer can further be improved. As a result, a retardation film having further superior optical characteristic realizing properties can be obtained by the present invention.

Moreover, in the present invention, it is preferable that the wavelength dependency of the in-plane retardation (Re¹) of the optically anisotropic film is of the normal dispersion type. Thereby, the retardation film of the present invention can be provided with the further superior viewing angle compensating function of the liquid crystal display.

Furthermore, in the present invention, it is preferable that the cellulose derivative is triacetyl cellulose. Since triacetyl cellulose has excellent optical isotropy, by use of triacetyl cellulose as the cellulose derivative, design of the optical characteristics of the retardation film of the present invention can be facilitated, and thus it is advantageous.

To solve the above-mentioned problems, the present invention further provides a polarizing plate comprising: the retardation film rescited in the above-mentioned embodiment, a polarizer formed on a plane opposite to a side with the retardation layer formed, and a polarizing plate protection film formed on the polarizer.

According to the present invention, since the retardation film of the present invention is used as one of the polarizing plate protection films, a polarizing plate having excellent durability and a viewing angle compensating function for the liquid crystal display of the IPS system can be obtained.

In the present invention, it is preferable that the polarizing plate protection film is made of a cycloolefin resin or an acrylic resin. Thereby, the polarizing plate of the present invention can be provided with the excellent optical characteristic endurance.

To solve the above-mentioned problems, the present invention further provides a retardation film comprising: an optically anisotropic film having; a transparent substrate made of a cellulose derivative, and an optically anisotropic layer, formed on the transparent substrate, containing the cellulose derivative for comprising the transparent substrate, and an optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and a retardation layer, formed on the optically anisotropic film, containing a liquid crystal material with a homeotropic orientation formed, in which refractive indices nx₂ and ny₂ of optional x and y directions orthogonal with each other in the in-plane direction and a refractive index nz₂ of a thickness direction satisfy the formula of nx₂<ny₂<nz₂, wherein a Nz factor (Nz) is in the range of −0.5<Nz<0.5, and an in-plane retardation (Re) is in the range of 50 nm<Re<170 nm.

According to the present invention, since the optically anisotropic film has the configuration with the optically anisotropic layer containing the optically anisotropic material laminated on the transparent substrate made of a cellulose derivative, and the retardation layer contains a liquid crystal material with the homeotropic orientation formed, the optical characteristics of the retardation film as a whole can be adjusted in a predetermined range by for example, changing the thickness of the optically anisotropic layer or the retardation layer. Moreover, since the optically anisotropic material contained in the optically anisotropic layer and the liquid crystal material contained in the retardation layer both show excellent refractive index anisotropy, a wide range of the optical characteristics can be realized by the present invention.

Moreover, according to the present invention, since desired optical characteristics can be realized without having a hydrophobic compound contained in the transparent substrate, the adhesion properties of the transparent substrate to a hydrophilic polarizer cannot be deteriorated. Therefore, according to the present invention, a retardation film having excellent adhesion properties to a polarizer can be obtained.

Furthermore, according to the retardation film of the present invention, since the Nz factor and the in-plane retardation are in the ranges, an excellent viewing angle compensating function of the liquid crystal display of the IPS system can be provided.

Accordingly, in the present invention, a retardation film to be used preferably as a viewing angle compensating film for the liquid crystal display of the IPS system, with a wide range of the realizable optical characteristics and the easy adjusting properties for the optical characteristics can be obtained.

In the present invention, an in-plane retardation (Rth²) of the optically anisotropic film is preferably in the range of 50 nm<Re¹<170 nm, and a Nz factor (Nz¹) is in the range of 1.0<Nz<3.0.

Further in the present invention, a retardation in the out-of-plane thickness direction of the retardation layer (Rth²) is preferably in the range of −270 nm<Rth²<−50 nm. Since the optically anisotropic film and the optical characteristics of the retardation layer are each in the ranges, the retardation film of the present invention can be provided with an excellent viewing angle compensating function of the liquid crystal display of the IPS system.

Furthermore, in the present invention, it is preferable that the cellulose derivative is triacetyl cellulose. Since triacetyl cellulose has an excellent optical isotropy, by use of the triacetyl cellulose as the cellulose derivative, design of the optical characteristics of the retardation film of the present invention can be facilitated, and thus it is advantageous.

In the retardation film of the present invention, the Nz factor (Nz) may be in the range of −0.5<Nz<0.3.

Further, in the retardation film of the present invention, the retardation layer may be formed on the optically anisotropic layer of the optically anisotropic film.

According to the present invention, a highly durable polarizing plate having the viewing angle compensating function by being used as a polarizing plate protection film can be obtained and furthermore, the effect of providing a retardation film having excellent optical characteristic realizing properties can be achieved.

Moreover, according to the present invention, the effect of providing a retardation film to be used preferably as a viewing angle compensating film for the liquid crystal display of the IPS system with a wide range of realizable optical characteristics, excellent adhesion properties to a polarizer, and the easy adjustment of the optical characteristics can be achieved.

### BRIEF DESCRIPTION OF THE DRAWINGS

FIG. 1 is a schematic diagram showing an example of a retardation film of the first embodiment of the present invention.

FIGS. 2A and 2B are each a schematic diagram showing an example of an optically anisotropic film comprising the retardation film of the first embodiment of the present invention.

FIGS. 3A and 3B are each a schematic diagram showing another example of a retardation film of the first embodiment of the present invention.

FIG. 4 is a schematic diagram showing one example of a retardation film of the second embodiment of the present invention.

FIG. 5 is a schematic diagram showing another example of a retardation film of the second embodiment of the present invention.

FIG. 6 is a schematic diagram showing an example of a polarizing plate of the present invention.

FIG. 7 is a schematic diagram showing an example of a polarizing plate using a retardation film of the present invention.

FIG. 8 is a schematic diagram showing an example of an IPS cell to be produced with a retardation film of the present invention.

FIG. 9 is a schematic diagram showing an example of a liquid crystal display to be produced with a retardation film of the present invention.

FIG. 10 is a schematic diagram schematically showing a part of a common liquid crystal display.

FIG. 11 is a schematic diagram schematically showing a part of a liquid crystal display using a retardation film.

FIGS. 12A and 12B are each a schematic diagram showing an example of a use embodiment of a retardation film.

### DESCRIPTION OF THE PREFERRED EMBODIMENT

The present invention relates to a retardation film, and a polarizing plate using the same.

Hereafter, the retardation film and the polarizing plate of the present invention will be explained successively.

### A. Retardation Film

First, the retardation film of the present embodiment will be explained. The retardation film of this embodiment can be classified into two embodiments on the whole. Therefore, the retardation film of the present embodiment will be explained by each embodiment.

### A-1: Retardation Film of the First Embodiment

A retardation film of the first embodiment will be explained. A retardation film of the present embodiment comprises: an optically anisotropic film having; a transparent substrate made of a cellulose derivative, and an optically anisotropic layer, formed on the transparent substrate, containing the cellulose derivative for comprising the transparent substrate, and a first optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and a retardation layer, formed on the optically anisotropic film, containing a second optically anisotropic material showing a normal dispersion type wavelength dependency, in which refractive indices nx₂ and ny₂ of optional x and y directions orthogonal with each other in the in-plane direction and a refractive index nz₂ of a thickness direction satisfy the formula of nx₂≦ny₂<nz₂, wherein the first optically anisotropic material comprises a compound made of a polymerizable rodlike molecule having a structure with a polymerizable functional group and a mesogenic group bonded via an alkyl chain having 4 or more carbon atoms.

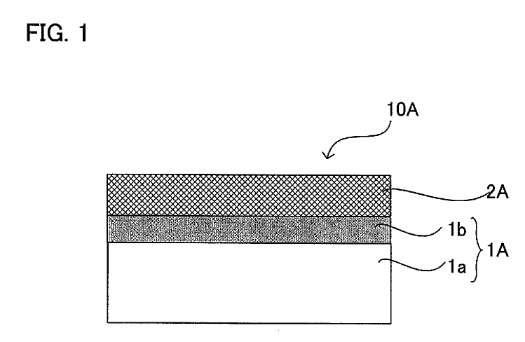

The retardation film of this embodiment will be explained with a reference to the drawings. FIG. 1 is a schematic diagram showing an example of a retardation film of this embodiment. As it is shown in FIG. 1, the retardation film 10A of this embodiment comprises: an optically anisotropic film 1A including a transparent substrate 1a made of a cellulose derivative, and an optically anisotropic layer 1b formed on the transparent substrate 1a; and a retardation layer 2A formed on the optically anisotropic layer 1b of the optically anisotropic film 1A.

Here, the optically anisotropic film 1A has the optically anisotropic layer 1b, in which a cellulose derivative for providing the transparent substrate 1a, and a first optically anisotropic material showing the normal dispersion type wavelength dependency of the retardation are contained; and the optically anisotropic film 1A as a whole has the optical characteristics satisfying the formula of nx₁>ny₁, in which the refractive index of the slow axis direction in the in-plane direction is nx₁ and the refractive index of the fast axis direction in the in-plane direction is ny₁.

Moreover, the retardation layer 2A contains a second optically anisotropic material showing the normal dispersion type wavelength dependency, wherein the retardation layer 2A as a whole has the optical characteristics satisfying the formula of nx₂≦ny₂<nz₂, in which the refractive indices in the optional x and y directions orthogonal with each other in the in-plane direction are nx₂ and ny₂ and the refractive index of the thickness direction is nz₂.

In such an example, according to the retardation film 10A of this embodiment, the first optically anisotropic material contained in the optically anisotropic layer 1b includes a compound made of a polymerizable rodlike molecule having a structure with a polymerizable functional group and a mesogenic group bonded via an alkyl chain having 4 or more carbon atoms.

According to this embodiment, since the first optically anisotropic material contains a compound made of a polymerizable rodlike molecule having a structure with a polymerizable functional group and a mesogenic group bonded via an alkyl chain having 4 or more carbon atoms, the optically anisotropic layer can be provided with the excellent optical anisotropy realizing properties of nx₁>ny₁. Therefore, according to this embodiment, for example, since a high optical anisotropy can be realized with a thin thickness optically anisotropic layer, a retardation film having the excellent optical characteristic realizing properties can be obtained.

Here, although the reason why the optically anisotropic layer can be provided with the excellent optical anisotropy realizing properties by containing a compound made of a polymerizable rodlike molecule having a structure with a polymerizable functional group and a mesogenic group bonded via an alkyl chain having 4 or more carbon atoms in the first optically anisotropic material is not clear, it is considered to be as follows.

That is, the optically anisotropic layer has the optical anisotropy realized by the first optically anisotropic material. Here, since the first optically anisotropic material has the birefringence index, by the regular alignment with the optical axis oriented in one direction, the optical anisotropy can be provided to the optically anisotropic layer. Then, in the first optically anisotropic material, a molecule has the electric dipole moment vector oriented to a specific direction with respect to the molecule axis (in general, the direction of the electric dipole moment vector coincides with the molecule axis direction in many cases, however, it may be orthogonal to the molecule axis, or the like). Therefore, alignment of the optical axes in one direction corresponds to alignment of the axes directions of the rod like molecules in one direction. Therefore, in order to have the first optically anisotropic material provided with the excellent optical anisotropy realizing properties, it is considered that making a structure of the rodlike molecules to the structure unit contributing to the optical anisotropy realizing properties to be aligned easily to one direction would be effective.

In this regard, since the compound made of a polymerizable rodlike molecule has a mesogenic group contributing to the optical anisotropy realizing properties with a structure bonded with a polymerizable functional group via an alkyl group, and since the alkyl group has 4 or more carbon atoms, the mesogenic group can be provided with the freedom to the extent not to hinder the alignment properties.

Therefore, since the mesogenic group can realize the excellent alignment properties in the optically anisotropic layer, the optically anisotropic layer is thought in the present embodiment to be able to obtain the excellent optical anisotropy realizing properties.

Moreover, according to this embodiment, since the transparent substrate made of a cellulose derivative is used for the optically anisotropic film, in the case of using the retardation film of this embodiment for the inner side polarizing plate protection film, a polarizing plate protection film made of a cycloolefin resin can be used for the outer side polarizing plate protection film so that a polarizing plate with the excellent endurance can be obtained.

Furthermore, according to this embodiment, since the retardation layer has the optical characteristics satisfying the formula of nx≦ny<nz and the optically anisotropic film has the optical characteristics satisfying the formula of nx>ny, by using the retardation film of this embodiment for the polarizing plate protection film, a polarizing plate having the viewing angle compensating function of the liquid crystal display of the IPS system can be obtained.

Accordingly, in this embodiment, a highly durable polarizing plate having the viewing angle compensating function by use as a polarizing plate protection film can be obtained and furthermore, a retardation film having the excellent optical characteristic realizing properties can be obtained.

According to this embodiment, the optically anisotropic layer includes the first optically anisotropic material having the normal dispersion type wavelength dependency for the wavelength dependency of the retardation value. In this embodiment, the “normal dispersion type” denotes the case that the retardation value is a decreasing function of the wavelength. Specifically, it denotes a type of the wavelength dependency with the ratio (Re₄₅₀/Re₅₅₀) of the in-plane retardation at the 450 nm wavelength (Re₄₅₀) and the in-plane retardation at the 550 nm wavelength (Re₅₅₀) of more than 1 (hereafter, it may be referred to simply as the “Re ratio”).

Moreover, according to this embodiment, in the case the retardation value is an increasing function of the wavelength, that is, a type of the wavelength dependency with the Re ratio of less than 1 is referred to as the “anomalous dispersion type”. In the case the retardation value is a constant function of the wavelength, that is, a type of the wavelength dependency with the Re ratio of 1 is referred to as the “flat type”. The definition of Re is as explained in “3. Retardation film” to be described later.

Moreover, the in-plane retardation and the out-of-plane direction retardation in this embodiment denote values with respect to the 550 nm wavelength unless the wavelength is specified otherwise.

The retardation film of this embodiment comprises at least the optically anisotropic film and the retardation layer.

Hereafter, each configuration used in the retardation film of this embodiment will be explained in detail.

### 1. Optically Anisotropic Film

First, the optically anisotropic film used in this embodiment will be explained. The optically anisotropic film used in this embodiment comprises: a transparent substrate made of a cellulose derivative;, and an optically anisotropic layer formed on the transparent substrate and containing the cellulose derivative for comprising the transparent substrate, and a first optically anisotropic material showing the normal dispersion type wavelength dependency of the retardation, in which the refractive index nx₁ of the slow axis direction in the in-plane direction and the refractive index ny₁ of the fast axis direction in the in-plane direction satisfy the formula of nx₁>ny₁. Then, according to the optically anisotropic film of this embodiment, the first optically anisotropic material includes a compound made of a polymerizable rodlike molecule having a structure with a polymerizable functional group and a mesogenic group bonded via an alkyl chain having 4 or more carbon atoms.

Hereafter, such an optically anisotropic film will be explained in detail.

### (1) Optically Anisotropic Layer

First, the optically anisotropic layer used in this embodiment will be explained. The optically anisotropic layer used in this embodiment is formed on the transparent substrate to be described later and comprises: a cellulose derivative comprising the transparent substrate and a first optically anisotropic material which shows the normal dispersion type wavelength dependency of the retardation, and includes a compound made of a polymerizable rodlike molecule having a structure with a polymerizable functional group and a mesogenic group bonded via an alkyl chain having 4 or more carbon atoms.

a. First Optically Anisotropic Material

First, the first optically anisotropic material will be explained. The first optically anisotropic material used in this embodiment has normal dispersion type wavelength dependency of the retardation, and contains a compound made of the polymerizable rodlike molecule.

The first optically anisotropic material used in this embodiment is not particularly limited as long as its wavelength dependency of the retardation is of the normal dispersion type and it contains a compound made of the polymerizable rodlike molecule so that one capable of providing desired retardation properties to the retardation film of this embodiment may be selected and used optionally according to factors such as the application of the retardation film of this embodiment. In particular, it is preferable that the first optically anisotropic material used in this embodiment has the Re ratio in a range of 1 to 2.

Here, the Re ratio of the first optically anisotropic material can be calculated by forming a layer of the first optically anisotropic material on an isotropic base material such as a glass substrate, with an alignment film of such as polyimide formed and the alignment process applied, and measuring Re at the 450 nm wavelength (Re₄₅₀) and the 550 nm wavelength (Re₅₅₀).

The compound made of a polymerizable rodlike molecule to be contained in the first optically anisotropic material used in this embodiment is not particularly limited as long as it has a structure with a polymerizable functional group and a mesogenic group bonded via an alkyl chain having 4 or more carbon atoms so that one capable of providing desired optically anisotropic properties to the optically anisotropic layer can be selected and used optionally according to factors such as the application of the retardation film of this embodiment. As a compound having such a structure, a polymerizable liquid crystal compound can be presented as a representative example.

As the polymerizable liquid crystal compound used in this embodiment, a polyfunctional polymerizable liquid crystal compound having a plurality of polymerizable functional groups, and a monofunctional polymerizable liquid crystal compound having a single polymerizable functional group can be presented. In this embodiment, both the polyfunctional polymerizable liquid crystal compound and the monofunctional polymerizable liquid crystal compound can be used preferably. In particular, it is preferable to use the monofunctional polymerizable liquid crystal compound in this embodiment. According to the monofunctional polymerizable liquid crystal compound, the freedom of the mesogenic group can be made higher than that of the polyfunctional polymerizable liquid crystal compound. Furthermore, owing to the low density of the cross-linking points binding and hindering the re-alignment of the molecules, the alignment of the molecules (their electric dipole moment vectors) can be facilitated in the case of carrying out the drawing treatment after the polymerizable. Therefore, by use of the monofunctional polymerizable liquid crystal compound, the optically anisotropic layer can be provided with further superior optical anisotropy realizing properties.

Moreover, according to the polymerizable liquid crystal compound used in this embodiment, the alkyl chain bonding the mesogenic group and the polymerizable functional group, having 4 or more carbon atoms is not particularly limited as long as it has 4 or more carbon atoms. In particular, the polymerizable liquid crystal compound used in this embodiment preferably has the carbon atoms comprising the alkyl chain in a range of 5 to 12, and particularly preferably in a range of 6 to 10. Since the number of carbon atoms is in the range, the mesogenic group of the polymerizable liquid crystal compound can be provided with a higher freedom of the molecule alignment so that the optical anisotropy realizing properties of the optically anisotropic layer can further be improved.

The “number of the carbon atoms comprising the alkyl chain” in this embodiment denotes the number of the carbon atoms comprising the principal chain portion of the alkyl group bonding the polymerizable functional group and the mesogenic group. Therefore, for example, in the case the alkyl group is a branched chain having a side chain, the number of the carbon atoms comprising the side chain is not included in the “number of the carbon atoms comprising the alkyl chain”.

The alkyl chain used in this embodiment is not particularly limited as long as the number of the carbon atoms is in the range. Therefore, the alkyl chain used in this embodiment may either be a straight chain without a side chain or a branched chain having a side chain. Moreover, it may either be a saturated alkyl chain having only a saturated bond, or an unsaturated alkyl chain having an unsaturated bond. Furthermore, it may have a structure with an optional function group bonded to a hydrocarbon chain.

Moreover, in this embodiment, in the case of using the polyfunctional polymerizable liquid crystal compound, the numbers of carbon atoms comprising the alkyl chains bonded to the respective polymerizable functional groups may be same or different.

The mesogenic group used for the polymerizable liquid crystal compound is not particularly limited as long as it can provide predetermined optically anisotropic properties to the optically anisotropic layer by its regular alignment. In particular, in this embodiment, one having a rodlike structure is used in general as the mesogenic group because a mesogenic group having a rodlike structure can easily realize the optical anisotropy by its regular alignment.

Here, the “rodlike structure” denotes a compound having the principal skeleton of the mesogenic group structure of a rodlike form.

Moreover, as the mesogenic group used in this embodiment, among the mesogenic groups having the rodlike structure, one showing liquid crystalline properties is preferable. Since the mesogenic group showing the liquid crystalline properties is used, the desired optically anisotropic properties can easily be provided to the optically anisotropic film of this embodiment.

In the case of using one having the liquid crystalline properties as the mesogenic group, the kind of the liquid crystal phase of the mesogenic group is not particularly limited. As such a liquid crystal phase, for example, the nematic phase, the cholesteric phase, the smectic phase, or the like can be presented. In this embodiment, a mesogenic group showing any of the liquid crystal phases can be used preferably. In particular, it is preferable to use a mesogenic group showing the nematic phase because it facilitates the regular alignment compared with a mesogenic group showing the other liquid crystal phases.

As a specific example of such a mesogenic group, for example, those having two or more ring structures represented by the following formulae (1) to (11) bonded directly or via a binding group can be presented.

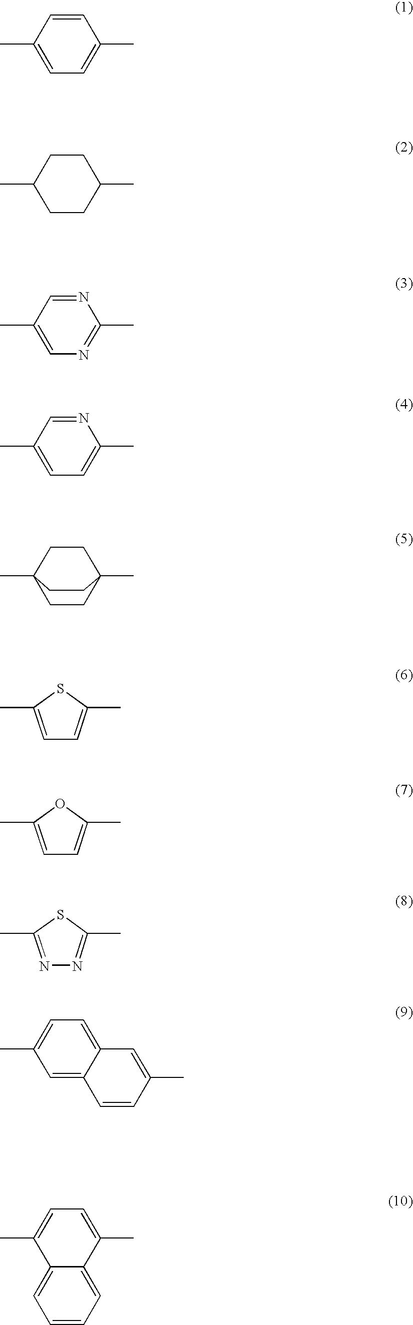

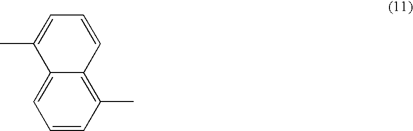

Here, an optional hydrogen in the ring structures of the formulae (1) to (11) may be substituted by halogen, —CN, —CF₃, —CF₂H, —NO₂ or alkyl having 1 to 7 carbon atoms. In the alkyl having 1 to 7 carbon atoms, optional —CH₂— may be substituted by —O—, —CH═CH— or —C≡C—, and furthermore, optional hydrogen may be substituted by halogen.

Moreover, the binding group is not particularly limited as long as it can bind the ring structure by a predetermined distance. As such a binding group, for example, those represented by the following formulae (12) to (23) can be presented.

—COO— (12)

—OCO— (13)

—CH₂CH₂— (14)

—CH═CH— (15)

—C≡C— (16)

—N═N— (17)

—CH₂O— (18)

—CO—S— (19)

—CONH— (20)

—COO—N═CH— (21)

—CH═N— (22)

—CH═CH—COO— (23)

The polymerizable functional group to be used for the polymerizable liquid crystal compound is not particularly limited as long as it can be polymerized by carrying out a desired polymerization process so that it can be selected and used optionally according to factors such as the production method for a retardation film of this embodiment. As such a polymerizable functional group, for example, a polymerizable functional group to be polymerized by the function of an ionizing radiation such as an ultraviolet ray and an electron beam, or heat can be presented. As a representative example of the polymerizable functional groups, a radically polymerizable functional group, a cationically polymerizable functional group, or the like can be presented. Furthermore, as a representative example of the radically polymerizable functional group, a functional group having at least one addition polymerizable ethylenically unsaturated double bond can be presented. As a specific example, a vinyl group with or without a substituent, an acrylate group (general term including an acryloyl group, a methacryloyl group, an acryloyloxy group, and a methacryloyloxy group), or the like can be presented. Moreover, as a specific example of the cationically polymerizable functional group, an epoxy group, or the like can be presented. Additionally, as a polymerizable functional group used in this embodiment, for example, an isocyanate group, an unsaturated triple bond, or the like can be presented. In this embodiment, among these polymerizable functional groups, a functional group having an ethylenically unsaturated double bond can be used preferably in terms of the process.

In the case of using the polyfunctional polymerizable liquid crystal compound as the polymerizable liquid crystal compound used in this embodiment, the polymerizable functional groups used for the polyfunctional polymerizable liquid crystal compound may either be same or different.

Moreover, it is preferable that the polymerizable liquid crystal compound used in this embodiment is a compound having a relatively small molecular weight. More specifically, the compound preferably has a molecular weight in a range of 200 to 1,200, and particularly preferably in a range of 400 to 1,000. The reason thereof is as follows.

That is, since the optically anisotropic layer used in this embodiment contains the first optically anisotropic material and the cellulose derivative comprising the transparent substrate to be described later. Since a compound having a relatively small molecular weight is used as the polymerizable liquid crystal compound, the polymerizable liquid crystal compound can easily be mixed with the cellulose derivative in the optically anisotropic layer. Therefore, by use of a polymerizable liquid crystal compound having he molecular weight in the range, the haze of the optically anisotropic layer can be made smaller.

The molecular weight of the polymerizable liquid crystal compound denotes the molecular weight in a state of the monomer before the polymerization.

As a specific example of the polymerizable liquid crystal compound used in this embodiment, compounds represented by the following formulae can be presented.

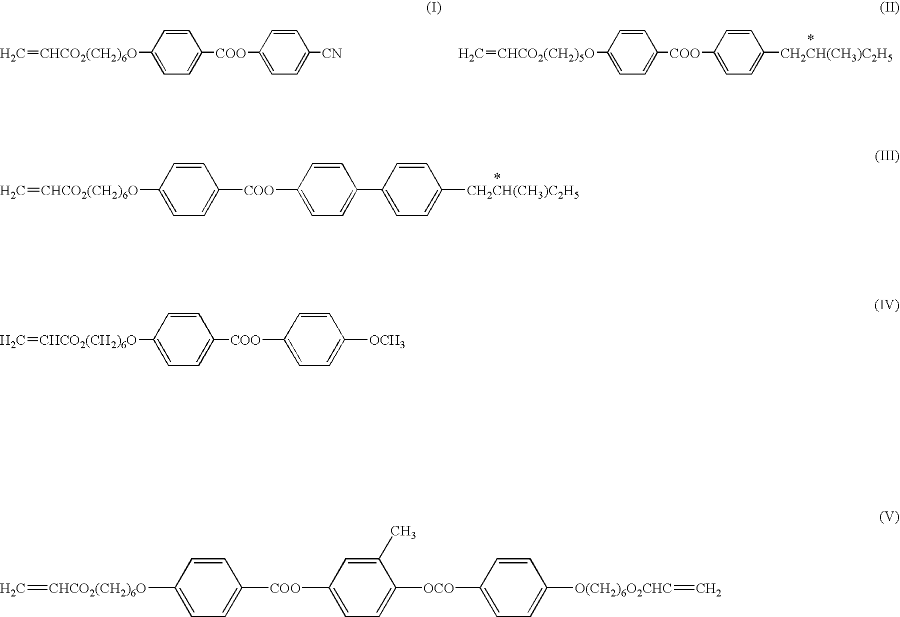

Here, the polymerizable liquid crystal compounds represented by the formulae (I), (IV), and (V) can be prepared according to the methods disclosed by D. J. Broeret, al., Makromol Chem. 190, 3201-3215 (1989), or by D. J. Broer et, al., Makromol Chem. 190, 2250 (1989), or by a similar method. Moreover, preparation of the polymerizable liquid crystal compounds represented by the chemical formulae (II) and (III) is disclosed in DE 195,04,224.

Moreover, as an example of the polymerizable liquid crystal compound used in this embodiment, for example, compounds represented by the following formulae can be presented.

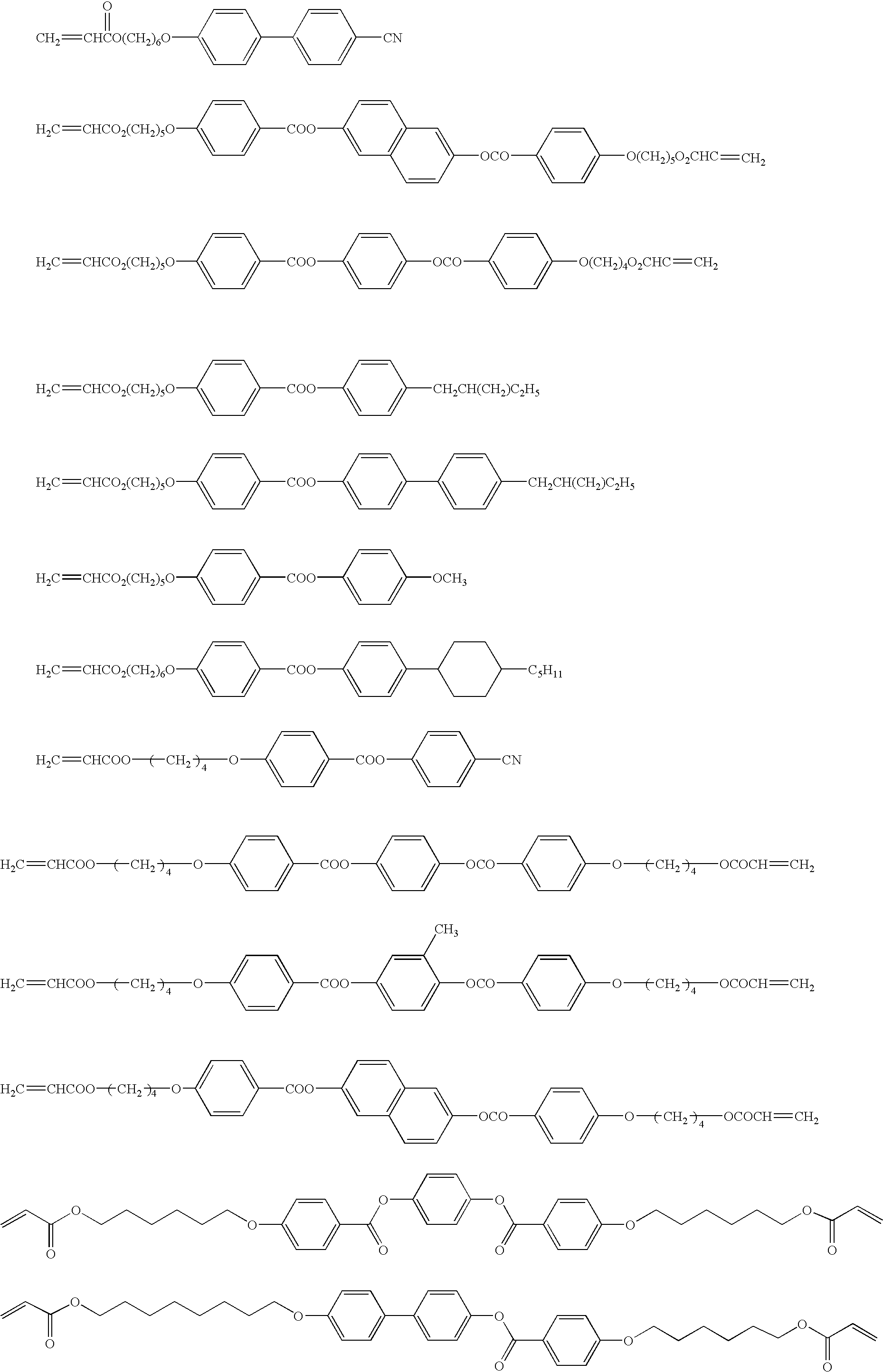

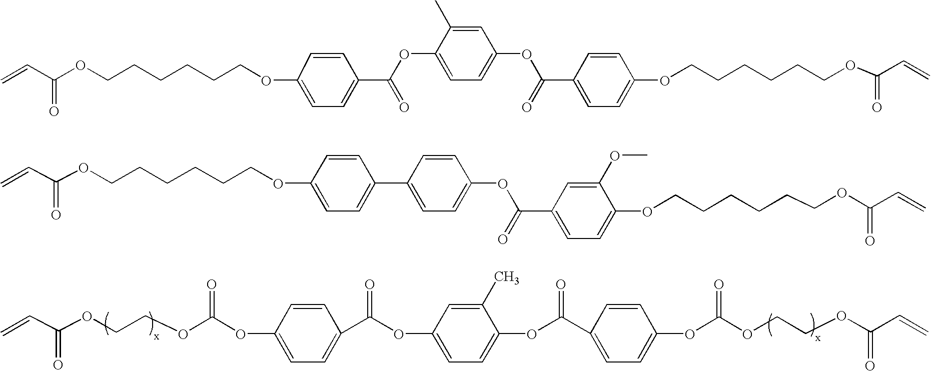

x is an integer from 4 to 12.

It is preferable that the first optically anisotropic material used in this embodiment includes the polymerizable liquid crystal compound. The polymerizable liquid crystal compound contained in the first optically anisotropic material may either be only one kind or two or more kinds.

Moreover, in the case two or more kinds of the polymerizable liquid crystal compounds are included in the first optically anisotropic material, the polymerizable liquid crystal compound may be selected only from the monofunctional polymerizable liquid crystal compounds, it may be selected only from the polyfunctional polymerizable liquid crystal compounds, or it may be selected from both the monofunctional polymerizable liquid crystal compounds and the polyfunctional polymerizable liquid crystal compounds. In particular, in this embodiment, it is preferable that at least the monofunctional polymerizable liquid crystal compounds are selected because, as mentioned above, the monofunctional polymerizable liquid crystal compounds have the excellent optical anisotropy realizing properties.

Moreover, as an embodiment of the first optically anisotropic material used in this embodiment including the polymerizable liquid crystal compound, it may either be an embodiment with the first optically anisotropic material made of only the polymerizable liquid crystal compound, or an embodiment with the first optically anisotropic material provided as a mixture of the polymerizable liquid crystal compound and another compound.

In the case the first optically anisotropic material used in this embodiment is a mixture of the polymerizable liquid crystal compound and another compound, the content of the polymerizable liquid crystal compound contained in the first optically anisotropic material is not particularly limited as long as it is in a range capable of providing the desired optically anisotropic properties to the optically anisotropic layer so that it can be provided in an optional range according to factors such as the kind of the other optically anisotropic compound or the kind of the polymerizable liquid crystal compound. In particular, in this embodiment, the content of the polymerizable liquid crystal compound is preferably in a range of 30% by mass to 95% by mass, it is particularly preferably in a range of 50% by mass to 98% by mass, and it is further preferably in a range of 60% by mass to 99.9% by mass.

Moreover, as the other compound, which is a mixture of the polymerizable liquid crystal compound and the other compound, to be used in the case of the first optically anisotropic material used in this embodiment, it is not particularly limited as long as it can provide a desired function to the optically anisotropic layer used in this embodiment. As such another compound, for example, a polymerizable liquid crystal compound having an optional structure capable of contributing to the realization of the optically anisotropic properties of the optically anisotropic layer, a non-polymerizable liquid crystal compound having an optional structure, a non-liquid crystalline polymerizable compound such as a polyfunctional acrylate, and an optional inorganic compound can be presented. In particular, in this embodiment, as the other compound, it is preferable to use the non-polymerizable liquid crystal compound or the non-liquid crystalline polymerizable compound. Here, use of the non-polymerizable liquid crystalline compound as the other compound contributes to the improvement of the reliability of the optically anisotropic film, easy control over rise of the haze caused in case of retardation layer lamination, and over the desired in-plane retardation value, and thus it is advantageous.

As the inorganic compound to be used as the other compound, powders of for example, metal oxide, metal nitride, metal carbide, metal halide, ferrite, metal hydroxide, metal salts (metal carbonate, metal sulfate, metal silicate, or the like) can be presented. In particular, it is preferable to use a color less, transparent inorganic compound having the optically anisotropic properties and a needle-like shape with the ratio of the shorter axis with respect to the longer axis of at least ¾ or less. As such an inorganic compound, for example, SiO, SiO₂, Bi₂O₅, ZnO, TiO₂, Nb₂O₃, ZrO₂, Y₂O₃, MnO, Al₂O₃, Sb₂O₃, Ta₂O₅, WO₃, SrCO₃, or the like can be presented.

In the case of using a mixture of the polymerizable liquid crystal compound and the other compound as the first optically anisotropic material, the polymerizable liquid crystal compound may be used either by only one kind or by two or more kinds.

b. Cellulose Derivative

Next, the cellulose derivative contained in the optically anisotropic layer to be used in this embodiment will be explained. The cellulose derivative used in this embodiment is a cellulose derivative comprising the transparent substrate to be described later. In this embodiment, since such a cellulose derivative in contained in the optically anisotropic layer, an optically anisotropic film having the excellent adhesion properties between the transparent substrate and the optically anisotropic layer can be obtained.

The amount of the cellulose derivative contained in the optically anisotropic layer in this embodiment is not particularly limited as long as the adhesion properties between the transparent substrate and the optically anisotropic layer can be provided in a desired range in the optically anisotropic film used in this embodiment. In particular, in this embodiment, the content of the cellulose derivative is preferably in a range of 1% by mass to 50% by mass, and it is particularly preferably in a range of 5% by mass to 30% by mass.

Since the cellulose derivative contained in the optically anisotropic layer is same as that to be explained as the cellulose derivative comprising the transparent substrate in the item of “(2) Transparent substrate” to be described later, explanation is not repeated here.

c. Optically Anisotropic Layer

The optically anisotropic layer used in this embodiment may contain compounds other than the first optically anisotropic material and the cellulose derivative. As such another compound, for example, silicon based leveling agents such as polydimethyl siloxane, methyl phenyl siloxane, and organic modified siloxane; straight chain polymerized products such as polyalkyl acrylate, and polyalkyl vinyl ether; surfactants such as fluorine based surfactant, and hydrocarbon based surfactant; fluorine based leveling agents such as tetrafluoroethylene; photo polymerization initiating agents, or the like can be presented. In particular, in this embodiment, it is preferable to include a photo polymerization initiating agent as the other compound. Since such a photo polymerization initiating agent is contained, polymerization reaction of the compound made of the polymerizable rodlike molecule contained in the first optically anisotropic material can be promoted in the process of producing the retardation film of this embodiment.

As the polymerization initiating agent used in the present embodiment, for example, benzophenone, o-benzoyl methyl benzoate, 4,4-bis(dimethyl amine) benzophenone, 4,4-bis (diethyl amine) benzophenone, α-amino-acetophenone, 4,4-dichlorobenzophenone, 4-benzoyl-4-methyldiphenylketone, dibenzyl ketone, fluolenone, 2,2-diethoxy acetophenone, 2,2-dimethoxy-2-phenyl acetophenone, 2-hydroxy-2-methyl propiophenone, p-tert-butyl dichloroacetophenone, thioxantone, 2-methyl thioxantone, 2-chlorothioxantone, 2-isopropyl thioxantone, diethyl thioxantone, benzyl dimethyl ketal, benzyl methoxy ethyl acetal, benzoin methyl ether, benzoinbutyl ether, anthraquinone, 2-tert-butyl anthraquinone, 2-amyl anthraquinone, β-chloranthraquinone, anthrone, benzanthrone, dibenzsuberone, methyleneanthrone, 4-adidobenzyl acetophenone, 2,6-bis(p-adidobendilidene)cyclohexane, 2,6-bis (p-adidobendilidene)-4-methyl cyclohexanone, 2-phenyl-1,2-butadion-2-(o-methoxy carbonyl)oxime, 1-phenyl-propane dion-2-(o-ethoxy carbonyl)oxime, 1,3-diphenyl-propane trion-2-(o-ethoxy carbonyl)oxime, 1-phenyl 3-ethoxy-propanetrion-2-(o-benzoyl)oxime, Michler's ketone, 2-methyl-1[4-(methyl thio)phenyl]-2-morpholino propane-1-on, 2-benzyl-2-dimethyl amino-1-(4-morpholino phenyl)-butanone, naphthalene sulfonyl chloride, quinoline sulfonyl chloride, n-phenyl thioacrydone, 4,4-azo bis isobuthylonitrile, diphenyl disulfide, benzthiazol disulfide, triphenyl phosphine, camphor quinine, N1717 produced by Asahi Denka Co., Ltd., carbon tetrabromate, tribromo phenyl sulfone, benzoin peroxide, eosin, or a combination of a photo reducing pigment such as a methylene blue and a reducing agent such as ascorbic acid and triethanol amine can be presented.

In the present embodiment, these photo polymerization initiating agents can be used only by one kind or as a combination of two or more kinds.

Furthermore, in the case of using the photo polymerization initiating agent, a photo polymerization initiating auxiliary agent is preferably used in combination. As such a photo polymerization initiating auxiliary agent used in the present embodiment, tertiary amines such as triethanol amine, and methyl diethanol amine; benzoic acid derivatives such as 2-dimethyl aminoethyl benzoic acid and 4-dimethyl amide ethyl benzoate, or the like can be presented, but it is not limited thereto.

In the case the photo polymerization initiating agent is contained in the optically anisotropic layer used in this embodiment, the content thereof is not particularly limited as long as it is in a range capable of polymerizing the rodlike compound in a desired time. In general, it is preferably in a range of 1 part by weight to 10 parts by weight, and it is particularly preferably in a range of 3 parts by weight to 6 parts by weight with respect to 100 parts by weight of the rodlike compound.

In the optically anisotropic layer used in this embodiment, the following compounds may be added in the range not to deteriorate the purpose of the present embodiment. As the compound to be added, for example, polyester (meth)acrylate obtained by reacting (meth)acrylic acid with a polyester prepolymer obtained by condensation of a polyhydric alcohol and a monobasic acid or a polybasic acid; polyurethane (meth)acrylate obtained by reacting a polyol group and a compound having two isocyanate groups, and reacting the reaction product with (meth) acrylic acid; a photopolymerizable compound such as epoxy (meth)acrylate obtained by reacting (meth)acrylic acid with an epoxy resins such as a bisphenol A type epoxy resin, a bisphenol F type epoxy resin, a novolak type epoxy resin, polycarboxylic acid glycidyl ester, polyol polyglycidyl ether, an aliphatic or alicyclic epoxy resin, an amino group epoxy resin, a triphenol methane type epoxy resin, and dihydroxybenzene type epoxy resin; or a photo polymerizable liquid crystalline compound having an acrylic group or a methacrylic group can be presented. Since the compounds mentioned above are added, the mechanical strength of the optically anisotropic layer used in the present embodiment can be improved so that the stability may be improved.

The thickness of the optically anisotropic layer used in this embodiment is not particularly limited as long as it is in a range capable of having the optical characteristics of the optically anisotropic film used in this embodiment at a desired value according to the kind of the first optically anisotropic material or the kind of the transparent substrate to be described later. In particular, in this embodiment it is preferably in a range of 0.5 μm to 20 μm.

### (2) Transparent Substrate

Next, the transparent substrate used for the optically anisotropic film in this embodiment will be explained. The transparent substrate used in this embodiment is made of a cellulose derivative.

The cellulose derivative comprising the transparent substrate used in this embodiment is not particularly limited as long as it has a desired water permeability and it permeates the moisture content contained in the polarizer for restraining the decline of the polarizing characteristics according to the time passage to a desired degree in the polarizing plate production process when using the retardation film of this embodiment is used as the polarizing plate protection film. In the present embodiment, cellulose esters are preferably used as the cellulose derivative. Among the cellulose esters, it is preferable to use cellulose acylates because the cellulose acylates are used widely in the industrial field and it is advantageous in terms of the accessibility convenience.

As the cellulose acylates, lower fatty acid esters having 2 to 4 carbon atoms are preferable. The lower fatty acid ester may be one including a single lower fatty acid ester such as cellulose acetate, or it may be one including a plurality of fatty acid esters such as cellulose acetate butylate and cellulose acetate propionate.

In the present embodiment, among the above-mentioned lower fatty acid esters, cellulose acetate can be used particularly preferably. As the cellulose acetate, it is preferable to use triacetyl cellulose having the average acetification degree of 57.5 to 62.5% (substitution degree: 2.6 to 3.0). Since triacetyl cellulose has a molecule structure having a relatively bulky side chain, by use of a transparent substrate made of such triacetyl cellulose, the adhesion properties between the transparent substrate and the optically anisotropic layer can further be improved.

Here, the above-mentioned acetification degree denotes the bonded acetic acid amount per cellulose unit mass, and it can be obtained by the measurement and the calculation of the acetylation degree in the ASTM: D-817-91 (testing method for the cellulose acetate, or the like). The acetylation degree of the triacetyl cellulose comprising the triacetyl cellulose film can be calculated by the method after removing the impurities such as the plasticizing agent contained in the film.

The transparency degree of the transparent substrate used in this embodiment may be determined optionally according to the transparency required to the retardation film of this embodiment, or the like. In general, the transmittance in the visible light range is preferably 80% or more, and it is more preferably 90% or more.

Here, the transmittance of the transparent substrate can be measured by the JIS K7361-1 (testing method of the total light transmittance of the plastic-transparent materials).

Moreover, the thickness of the transparent substrate used in this embodiment is not particularly limited as long as it is in a range capable of obtaining the necessary self supporting properties according to factors such as the application of the retardation film of this embodiment. Therefore, anyone in the thickness range to be referred to as the so-called plate, sheet or film can be used optionally. In particular, the thickness of the transparent substrate used in this embodiment is preferably in a range of 10 μm to 188 μm, it is particularly preferably in a range of 20 μm to 125 μm, and it is further preferably in a range of 30 μm to 80 μm. If the thickness of the transparent substrate is thinner than the range, the self supporting properties necessary for the retardation film of this embodiment may not be provided. Moreover, if the thickness is thicker than the range, for example, at the time of the cutting process of the retardation film of this embodiment, dusts may be increased or wear of the cutting blade may be facilitated.

Moreover, the in-plane retardation of the transparent substrate used in this embodiment is not particularly limited as long as it is in a range capable of providing the desired retardation properties to the retardation film of this embodiment so that it can be adjusted optionally according to the application of the retardation film of this embodiment and the specific embodiment of the optically anisotropic film used in this embodiment. In particular, it is preferable that the transparent substrate used in this embodiment has the in-plane retardation at the 550 nm wavelength in a range of 0 nm to 50 nm. The definition of the in-plane retardation Re is as explained in “3. Retardation film” to be described later.

Here, the wavelength dependency of the in-plane retardation of the transparent substrate to be used in this embodiment may either be of the anomalous dispersion type, the normal dispersion type or the flat dispersion type.

Moreover, it is preferable that the transparent substrate used in this embodiment has the retardation in the out-of-plane direction at the 550 nm wavelength in a range of 0 nm to 100 nm.

It is preferable that the transparent substrate used in this embodiment has the value represented by the formula of the storage tensile elastic modulus×cross-sectional area larger than that of the optically anisotropic layer, and that the size shrinkage ratio is smaller than the size shrinkage ratio of the optically anisotropic layer. Since the transparent substrate having such characteristics, size change of the optically anisotropic layer according to passage of the time can be prevented effectively, and as a result, a retardation film having the excellent aging stability in the optical characteristics can be obtained in this embodiment.

The value represented by the formula of the storage tensile elastic modulus×cross-sectional area of the transparent substrate used in this embodiment can be adjusted optionally in preferable range according to the kind of the first optically anisotropic material contained in the optically anisotropic layer or application of the retardation film of this embodiment. In particular, the value represented by the formula of the storage tensile elastic modulus×cross-sectional area of the transparent substrate used in this embodiment is preferably 10 times or more of the value represented by the formula of the storage tensile elastic modulus×cross-sectional area of the optically anisotropic layer, it is particularly preferably 20 times or more, and it is further preferably 35 times or more. Since the size stability of the optically anisotropic film used in this embodiment can be further dominant thereby to the dynamic characteristics of the transparent substrate, for example the dynamic characteristics of the entire optically anisotropic film can be controlled by controlling the dynamic characteristics of the transparent substrate. Thus, design of the aging stability of the optical characteristics in the optically anisotropic film used in this embodiment can be facilitated, and it is advantageous.

The specific range of the value represented by the formula of the storage tensile elastic modulus×cross-sectional area of the transparent substrate used in this embodiment is in a range of 10,000N to 5,000,000N, it is more preferably in a range of 10,000N to 1,000,000N, and it is further preferably in a range of about 50,000N to 500,000N.

Here, the value represented by the formula of the storage tensile elastic modulus×cross-sectional area can be calculated by measuring the storage tensile elastic modulus in the following conditions using for example “Rheogel-E4000” produced by UBM Co., Ltd., and multiplying the measured value by the cross-sectional area of the transparent substrate.
Inter-chuck distance: 15 mm
Sample width: 5 mm
Distortion: 100 μm
Temperature rise speed: 3° C./min
Frequency: 10 Hz

In the case the storage tensile elastic modulus of the transparent substrate alone is difficult to be measured by the method due to permeation of the optically anisotropic layer to the transparent substrate, or the like in the optically anisotropic film used in this embodiment, the formula commonly known between the dynamic elastic modulus in the compression direction and the dynamic elastic modulus in the shearing direction, that is, the formula of “elastic modulus in the shearing direction=elastic modulus in the compression direction/3) can be utilized. That is, in the case the storage tensile elastic modulus of the transparent substrate alone is difficult to be measured, the compression elastic modulus can be used instead of the storage tensile elastic modulus.

In the case of using the compression elastic modulus instead of the storage tensile elastic modulus, the value represented by the formula of the compression elastic modulus×cross-sectional area of the transparent substrate is not particularly limited as long as it is in a range larger than the value represented by the formula of the compression elastic modulus×cross-sectional area of the optically an isotropic layer. In particular, the value of the formula of the compression elastic modulus×cross-sectional area of the transparent substrate in this embodiment, in the case the width of the transparent substrate is 1 m and the coating width of the optically anisotropic layer is 1 m is preferably in a range of 30,000N to 15,000,000N, it is particularly preferably in a range of 30,000N to 3,000,000N, and it is further preferably in a range of 150,000N to 1,500,000N.

Here, the compression elastic modulus is the value measured by the following conditions using ENT-1100a produced by ELIONIX CO., LTD.
Measurement depth: 500 nm
Measurement: sectioned by 500 points with the step interval per 1 point of 10 msec.

The “cross-sectional area” denotes the cross-sectional area of the cross-section in the direction perpendicular to the plane direction of the transparent substrate (thickness of the transparent substrate×width of the transparent substrate).

Moreover, the size shrinkage ratio of the transparent substrate used in this embodiment is not particularly limited as long as it is in a range smaller than the size shrinkage ratio of the optically anisotropic layer. In particular, the size shrinkage ratio of the transparent substrate used in this embodiment is preferably in a range of 0.01% to 1%, it is particularly preferably in a range of 0.01% to 0.1%, and it is further preferably in a range of 0.01% to 0.02%.

Here, the value represented by the size shrinkage ratio can be calculated by the following formula with the premise that the length of the transparent substrate drawn to the 1.4 times length with respect to the original length is La, and measuring the length Lb after passage of a day subsequent to the drawing operation:

Size shrinkage ratio=(La−Lb)/La.

Furthermore, it is preferable that the transparent substrate used in this embodiment has the excellent size stability in the high temperature and high humidity atmosphere. Since one having the excellent size stability in the high temperature and high humidity atmosphere is used as the transparent substrate, the size stability in the high temperature and high humidity atmosphere as the entire retardation film can be improved. As a result, a retardation film having a preferable stability in the optical characteristics also in the high temperature and high humidity atmosphere can be obtained. In particular, the size change ratio of the transparent substrate used in this embodiment after passage of 1 hour in the 90° C. temperature and 90% RH relative humidity environment is preferably 25% or less, it is particularly preferably in a range of 0.1% to 10%, and it is further preferably in a range of 0.1% to 5%.

The configuration of the transparent substrate used in this embodiment is not limited to the configuration comprising a single layer, but it may have a configuration with a plurality of layers laminated.

Moreover, in the case of the configuration with a plurality of layers laminated, layers of the same composition may be laminated, or a plurality of layers of different compositions may be laminated.

### (3) Optically Anisotropic Film

The optically anisotropic film used in this embodiment has the formula of nx₁>ny₁ satisfied between the refractive index nx₁ of the slow axis direction in the in-plane direction and the refractive index ny₁ of the fast axis direction in the in-plane direction. Therefore, the optically anisotropic film used in this embodiment has properties as the so-called A plate or B plate.

Here, as the embodiment satisfying the formula of nx₁>ny₁, the embodiments satisfying the formulas of nx₁>ny₁>nz₁, nx₁>nz₁>ny₁, nx₁>ny₁=nz₁, and nz₁>nx₁>ny₁ can be presented. As the optically anisotropic film used in this embodiment, one satisfying any of these formulas can be used preferably.

Re¹ of the optically anisotropic film used in this embodiment is not particularly limited as long as it is in a range capable of having the retardation properties of the retardation film of this embodiment in a desired range so that it can be adjusted optionally according to factors such as the application of the retardation film of this embodiment. In particular, in this embodiment, Re¹ of the optically anisotropic film is preferably in a range of 50 nm to 170 nm, and it is particularly preferably in a range of 70 nm to 150 nm. Since Re¹ is in such a range, the retardation film of this embodiment can be provided with the further superior viewing angle compensating function of the liquid crystal display of the IPS system.

Moreover, the wavelength dependency of Re¹ of the optically anisotropic film used in this embodiment may be any of the anomalous dispersion type, the normal dispersion type and the flat dispersion type. In particular, it is preferably of the normal dispersion type. The reason is as follows.

That is, since the retardation film of this embodiment has the configuration with the optically anisotropic film and the retardation layer to be described later laminated, for providing the excellent viewing angle compensating function of the liquid crystal display to the retardation film of this embodiment, it is preferable that the wavelength dependency of Re¹ of the optically anisotropic film and the wavelength dependency of Rth² of the retardation layer are of the same type. In this regard, since the retardation layer contains the second optically anisotropic material represented by the liquid crystal material with the homeotropic orientation formed, the wavelength dependency of Rth² is in general of the normal dispersion type. Therefore, since the wavelength dependency of Re¹ is of the normal dispersion type, by having both the wavelength dependencies of Re¹ and Rth² of the normal dispersion type, the excellent viewing angle compensating function of the liquid crystal display can be provided with the retardation film of this embodiment.

In the case the wavelength dependency of Re¹ of the optically anisotropic film used in this embodiment is of the normal dispersion type, the Re ratio is not particularly limited as long as it is in a range more than 1. In particular, in this embodiment, the Re ratio is preferably in a range of 1.01 to 1.3, and it is particularly preferably in a range of 1.01 to 1.2. Since the Re ratio is in such a range, the viewing angle isotropy of the liquid crystal display can be improved in a wider wavelength range by the retardation film of this embodiment.

Moreover, the Nz factor (Nz¹) of the optically anisotropic film used in this embodiment is not particularly limited as long as it is in a range capable of providing the retardation properties of the retardation film of this embodiment in a desired range. In particular, in this embodiment, the Nz factor (Nz¹) of the optically anisotropic film is preferably in a range of 1.0 to 3.0, and it is particularly preferably in a range of 1.0 to 2.0. Since the Nz factor (Nz¹) is in such a range, the retardation film of this embodiment can be provided with the further superior viewing angle compensating function of the liquid crystal display of the IPS system.

The Nz factor (Nz¹) of the optically anisotropic film can be represented by the following formula:

Nz¹=(Rth¹/Re¹)+0.5.

Here, Rth¹ and Re¹ mentioned above can be represented each by the following formulae using nx₁, ny₁, nz₁ mentioned above and the thickness of the optically anisotropic film d₁:

Re¹=(nx₁−ny₁)×d₁,

Rth¹=((nx₁+ny₁)/2−nz₁)×d₁.

Moreover, the Nz factor can be calculated according to the above-mentioned formula after measuring nx₁, ny₁ and nz₁ mentioned above by the parallel nicol rotation method using for example KOBRA-WR produced by Oji Scientific Instruments.

The optically anisotropic film used in this embodiment has the configuration with the optically anisotropic layer formed so as to be adhered on the transparent substrate. The adhesion degree of the optically anisotropic layer and the transparent substrate at the time is not particularly limited as long as it is in a range capable of controlling the dynamic characteristics of the optically anisotropic layer by the dynamic characteristics of the transparent substrate. In particular, in this embodiment, the adhesion degree is preferably in a range of 20/100 to 100/100 by the evaluation result of the cross cut method.

The “cross cut method” mentioned above is the evaluation method based on the Japan Industrial Standard JIS K5600-5-6 “paint general testing method—part 5: mechanical properties of the coating films—section 6: adhesion properties (cross cut method)” of cutting the coating surface side like a checkerboard of 1 mm square, attaching an adhesive tape (Cello tape (registered trademark produced by NICHIBAN CO., LTD.), thereafter peeling off the tape, and counting the number of the cells out of 100 cells of 1 mm square for evaluating the adhesion properties.

Moreover, the evaluation result of the cross cut method is represented by the number of the remaining portions out of the 100 checkerboard-like evaluating portions. For example, “20/100” mentioned above denotes that the number of the remaining portions without being peeled off out of the 100 evaluating portions was 20, and furthermore, “100/100” mentioned above denotes that the all 100 portions remain without being peeled off out of the 100 evaluating portions.

Moreover, in the optically anisotropic film used in this embodiment, the embodiment with the transparent substrate and the optically anisotropic layer laminated may be either: an embodiment with the transparent substrate and the optically anisotropic layer laminated as the individual layers, or an embodiment with the transparent substrate and the optically anisotropic layer laminated without a clear interface there between and with the content of the first optically anisotropic material changed continuously there between.

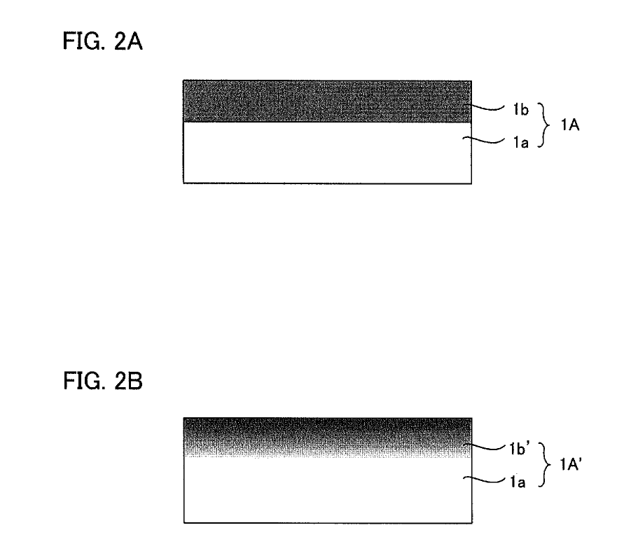

The embodiment with the transparent substrate and the optically anisotropic layer laminated in the optically anisotropic film used in this embodiment will be explained with reference to the drawings. FIGS. 2A and 2B are each a schematic diagram showing an example of the embodiment with the transparent substrate and the optically anisotropic layer laminated in the optically anisotropic film used in this embodiment. As shown in FIGS. 2A and 2B, the optically anisotropic films 1A and 1A′ used in this embodiment may be of either an embodiment with the transparent substrate 1a and the optically anisotropic layer 1b laminated as the individual layers (FIG. 2A), or an embodiment with the transparent substrate 1a and the optically anisotropic layer 1b′ laminated without a clear interface there between and with the content of the first optically anisotropic material changed continuously there between (FIG. 2B).

Moreover, the thickness of the optically anisotropic film used in this embodiment is not particularly limited as long as it is in a range capable of providing the optically anisotropic properties in a desired range. In particular, the thickness of the optically anisotropic film used in this embodiment is preferably in a range of 20 μm to 210 μm, it is particularly preferably in a range of 25 μm to 140 μm, and it is further preferably in a range of 30 μm to 90 μm.

According to the optically anisotropic film used in this embodiment, since the compound made of a polymerizable rodlike molecule is contained in the first optically anisotropic material, the desired optically anisotropic properties can be achieved with a thinner thickness.

### 2. Retardation Layer

Next, the retardation layer used in this embodiment will be explained. The retardation layer used in this embodiment contains the second optically anisotropic material showing the wavelength dependency of the normal dispersion type, in which the refractive indices nx₂ and ny₂ in the optional x and y directions orthogonal with each other in the in-plane direction and the refractive index nz₂ of the thickness direction satisfy the formula of nx₂≦ny₂<nz₂.

Hereafter, the retardation layer used in this embodiment will be explained.

### (1) Second Optically Anisotropic Material

First, the second optically anisotropic material used in this embodiment will be explained. The second optically anisotropic material used in this embodiment is not particularly limited as long as it is a material showing the wavelength dependency of the normal dispersion type and providing the retardation properties satisfying the formula of nx₂, ny₂ and nz₂ mentioned above. In particular, as the second optically anisotropic material used in this embodiment, it is preferable to use a homeotropic liquid crystal material.

It is preferable that the homeotropic liquid crystal material used in this embodiment has a polymerizable functional group. By use of such a homeotropic liquid crystal material, since polymerization can be carried out with each other via the polymerizable functional group, the mechanical strength of the retardation layer used in this embodiment can be improved. Moreover, the alignment stability of the homeotropic liquid crystal material in the retardation layer can be improved as well so that the retardation properties of nx₂≦ny₂<nz₂ can be provided stably to the retardation layer.

As the polymerizable functional group, various kinds of polymerizable functional groups to be polymerized by the function of the ionizing radiations such as the ultraviolet ray and the electron beam or the heat can be used. As representative examples of these polymerizable functional groups, a radically polymerizable functional group, a cationically polymerizable functional group, or the like can be presented.

As representative examples of the radically polymerizable functional group, a functional group having at least one addition polymerizable ethylenically unsaturated double bond can be presented. As a specific example, a vinyl group with or without a substituent, an acrylate group (general term including an acryloyl group, a methacryloyl group, an acryloyloxy group, and a methacryloyloxy group), or the like can be presented.

Moreover, as a specific example of the cationically polymerizable functional group, an epoxy group can be presented.

As another polymerizable functional group to be used in this embodiment, for example, an isocyanate group, an unsaturated triple bond, or the like can be presented.

In particular, in the present invention, among these polymerizable functional groups, a functional group having an ethylenically unsaturated double bond can be used preferably in terms of the process.

The homeotropic liquid crystal material used in this embodiment may have the polymerizable functional group by a plurality or by only one.

As the homeotropic liquid crystal material to be used in this embodiment, one having the homeotropic orientation properties capable of forming the homeotropic orientation without using a vertical alignment film (first homeotropic liquid crystal material), and one incapable of forming the homeotropic orientation by itself but capable of forming the homeotropic orientation by use of the vertical alignment film (second homeotropic liquid crystal material) can be presented. In this embodiment, not only the first homeotropic liquid crystal material, but also the second homeotropic liquid crystal material can be used preferably.

In the case of using the second homeotropic liquid crystal material in this embodiment, for the homeotropic orientation of the homeotropic liquid crystal material in the retardation layer, in general a method of using an alignment layer having the alignment limiting force for the homeotropic orientation of the liquid crystal material between the optically anisotropic film and the retardation layer mentioned above, or a method of employing an alignment controlling compound having the function of the homeotropically align the liquid crystal material in the retardation layer can be used. Moreover, a transfer method of independently forming the retardation layer with the second homeotropic liquid crystal material aligned homeotropically on the other substrate such as a glass substrate, peeling off the same for laminating on the optically anisotropic film can also be used. The method for forming the retardation layer on the glass substrate in such a transfer method is disclosed in for example the official gazette of the Japanese Patent Application Laid-Open No. 2003-177242, or the like.

The first homeotropic liquid crystal material is not particularly limited as long as it can form the homeotropic orientation without the need of using the vertical alignment film and provide desired retardation properties to the retardation layer to be used in this embodiment. As the first homeotropic liquid crystal material, for example, liquid crystal polymers such as a side chain type liquid crystal polymer comprising a monomer unit containing a liquid crystalline fragment side chain having the positive refractive index anisotropic properties and a monomer unit having a non-liquid crystalline fragment side chain, and a side chain type liquid crystal polymer containing a monomer unit containing the liquid crystalline fragment side chain and a liquid crystalline fragment side chain having an alicyclic ring-like structure can be presented. As the liquid crystal polymers, for example, the compounds disclosed in the official gazettes of the Japanese Patent Application Laid-Open Nos. 2003-121853, 2002-174725 and 2005-70098 can be presented.

On the other hand, the second homeotropic liquid crystal material is not particularly limited as long as it can form the homeotropic orientation by use of the vertical alignment film, or the like and provide desired retardation properties to the retardation layer to be used in this embodiment. In particular, in this embodiment, a nematic liquid crystal material showing the nematic phase can be used preferably.

As the specific examples of the second homeotropic liquid crystal material to be used in this embodiment, the compounds disclosed in the official gazettes of the Japanese Patent Application Laid-Open Nos. 10-508882, and 2003-287623 can be presented. In particular, in this embodiment, the compounds represented by the following formulae (24) to (40) can be used preferably as the second homeotropic liquid crystal material.

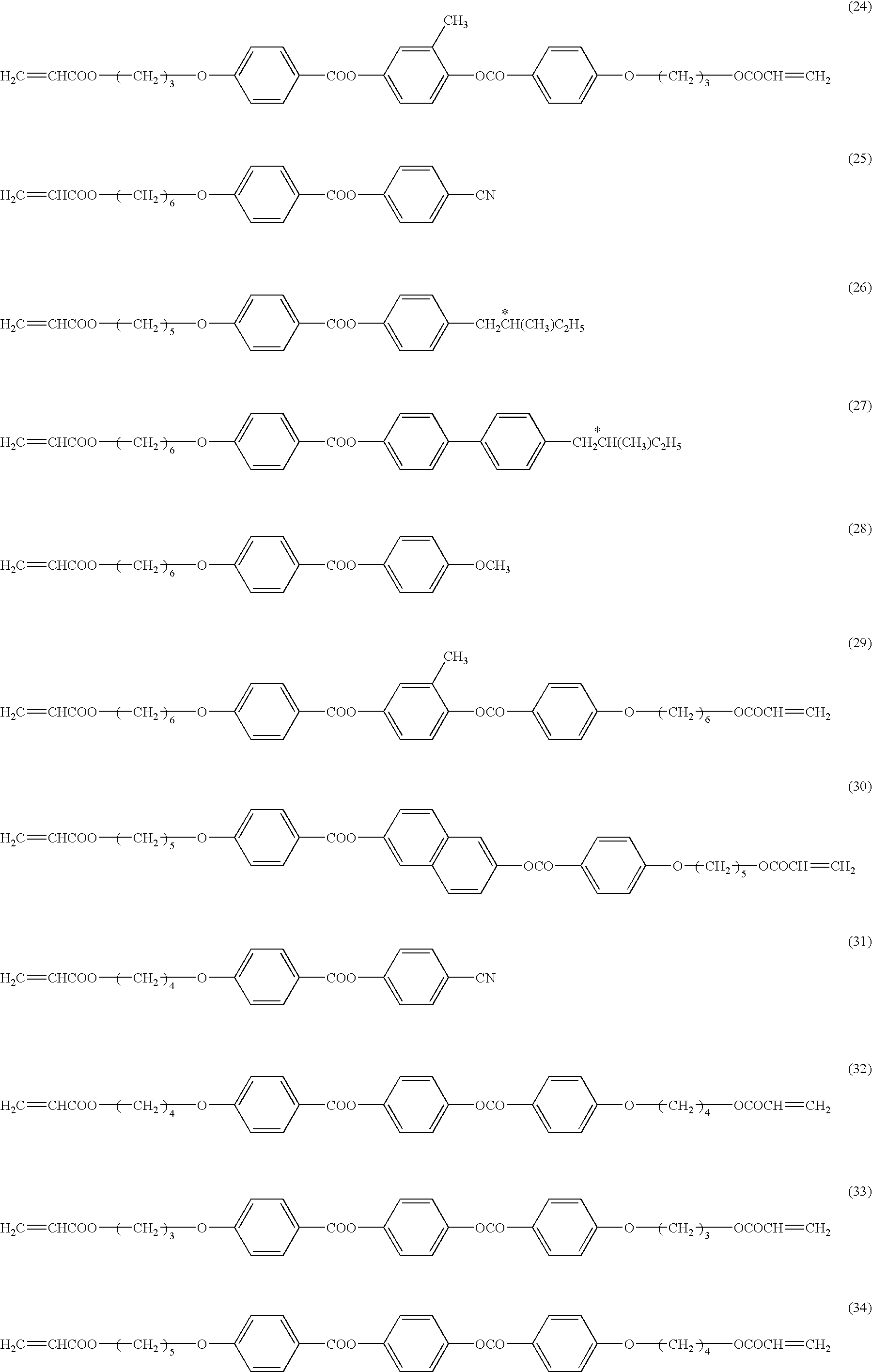

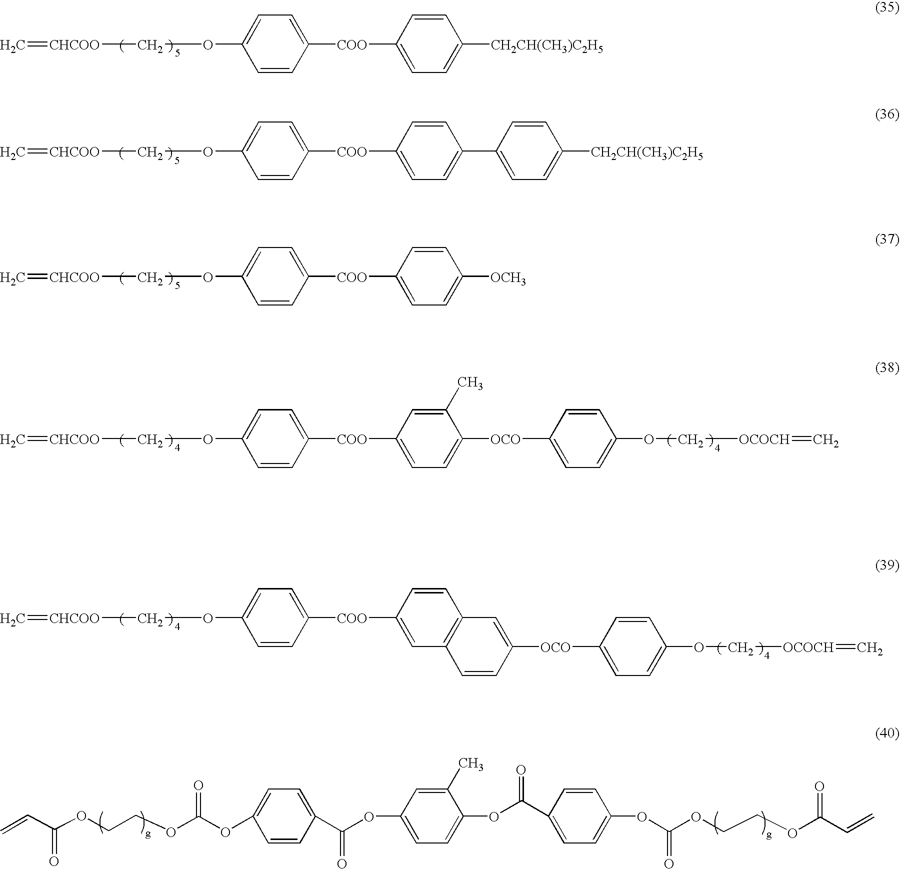

g: an integer from 2 to 10.

Moreover, as the second homeotropic liquid crystal material to be used in this embodiment, for example, the compounds disclosed in the official gazette of the Japanese Patent Application Laid-Open No. 10-319408 can be presented. In particular, in this embodiment, the compounds represented by the following chemical formulae can be used preferably.

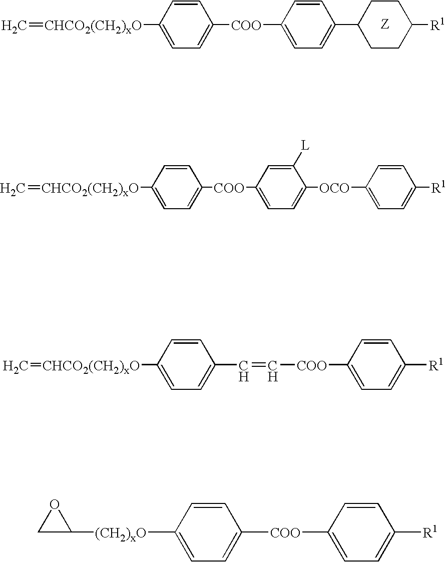

In the formulae, x is 1 to 12, Z is a 1,4-phenylene group or a 1,4-cyclohexylene group, R¹ is halogen or cyano, or an alkyl group or an alkoxy group having 1 to 12 carbon atoms, and L is H, halogen or CN, or an alkyl group, an alkoxy group or an acyl group having 1 to 7 carbon atoms.

In the case of using a compound having a polymerizable functional group as the homeotropic liquid crystal material, the homeotropic liquid crystal material contained in the retardation layer used in this embodiment is a polymerized product polymerized via the polymerizable functional group.

The homeotropic liquid crystal material to be used in this embodiment may be of one kind or two or more kinds. Moreover, in the case of using two or more kinds of the liquid crystal materials, the first homeotropic liquid crystal material and the second homeotropic liquid crystal material may be used as a mixture.

### (2) Other Compounds

The retardation layer to be used in this embodiment may contain compounds other than the second optically anisotropic material. The other compound is not particularly limited as long as it does not deteriorate the sequence state of the liquid crystal material in the retardation layer or the optical characteristic realizing properties of the retardation layer so that it can be selected and used optionally according to factors such as the application of the retardation film of this embodiment. In particular, as the other compound to be used preferably in this embodiment, an alignment controlling compound for aiding formation of the homeotropic orientation alignment of the liquid crystal material can be presented. Since the alignment controlling compound is used, the homeotropic liquid crystal material of the second embodiment can be used, and thus it is advantageous. Moreover, even in the case of using the homeotropic liquid crystal material of the first embodiment, the regularity of the homeotropic orientation alignment can be improved by use of the alignment controlling compound, and thus it is advantageous.

The alignment controlling compound is not particularly limited as long as it can provide the desired homeotropic orientation alignment limiting force to the retardation layer to be used in this embodiment. In particular, as the alignment controlling compound to be used in this embodiment, a surfactant can be used preferably. Since the surfactant is present eccentrically at the air interface in the retardation layer so as to align a specific direction of the molecules toward the retardation layer side, the homeotropic orientation alignment limiting force can easily be provided to the retardation layer.

As the surfactant to be used in this embodiment, for example, a sulfonate surfactant can be presented. In particular, a fluorinated sulfonate surfactant can be used preferably.

As a specific example of the fluorinated sulfonate surfactant, for example, product name: FC-4430, FC-4432 (produced by 3M Company) can be presented.

Moreover, as the other compound to be used in this embodiment, for example, a polymerization initiating agent, a polymerization inhibiting agent, a plasticizing agent, a surfactant, or a silane coupling agent can be presented.

Moreover, to the retardation layer to be used in this embodiment, the following compounds may be added in a range not to deteriorate the purpose of this embodiment. As the compounds to be added, for example, polyester (meth)acrylates obtained by reacting (meth)acrylic acid with a polyester prepolymer obtained by condensation of polyhydric alcohol and monobasic acid or polybasic acid; polyurethane (meth)acrylates obtained by reacting a polyol group and a compound having two isocyanate groups, and reacting the reaction product with (meth)acrylic acid; photopolymerizable compounds such as epoxy (meth)acrylate obtained by reacting (meth) acrylic acid with an epoxy resin such as a bisphenol A type epoxy resin, a bisphenol F type epoxy resin, a novolak type epoxy resin, polycarboxylic acid glycidyl ester, polyol polyglycidyl ether, an aliphatic or alicyclic epoxy resin, an amino group epoxy resin, a triphenol methane type epoxy resin, and a dihydroxybenzene type epoxy resin; or photo polymerizable liquid crystalline compounds having an acrylic group or a methacrylic group can be presented.

### (3) Retardation Layer

The retardation layer to be used in this embodiment has the formula of the refractive indices nx₂ and ny₂ in the optional x and y directions orthogonal with each other in the in-plane direction and the refractive index nz₂ of the thickness direction satisfying: nx₂≦ny₂<nz₂. Therefore, the retardation layer to be used in this embodiment has properties as the so-called positive C plate.

The retardation in the out-of-plane thickness direction of the retardation layer to be used in this embodiment (as to the definition of Rth², see “3. Retardation film” to be described later) is not particularly limited as long as it is in a range capable of having the retardation properties of the retardation film of this embodiment in a desired range. In particular, in this embodiment, it is preferable that Rth² mentioned above is in a range of −270 nm to −50 nm. Since Rth² mentioned above is in the range, the retardation film of this embodiment can be provided with the excellent viewing angle compensating function of the liquid crystal display of the IPS system.

Here, Rth² mentioned above can be measured by for example, by the parallel nicol rotation method using KOBRA-WR produced by Oji Scientific Instruments.

The thickness of the retardation layer in this embodiment is not particularly limited as long as it is in a range capable of providing the desired optical characteristics to the retardation layer according to factors such as the kind of the liquid crystal material. It is preferably in a range of 0.5 μm to 10 μm, it is more preferably in a range of 0.5 μm to 5 μm, and it is particularly preferably in a range of 1 μm to 3 μm.

Moreover, the retardation layer to be used in this embodiment is laminated on the optically anisotropic film mentioned above. As to the embodiment of laminating the retardation layer on the optically anisotropic film, it may be an embodiment of laminating on the optically anisotropic layer of the optically anisotropic film or it may be an embodiment of laminating on the transparent substrate of the optically anisotropic film.

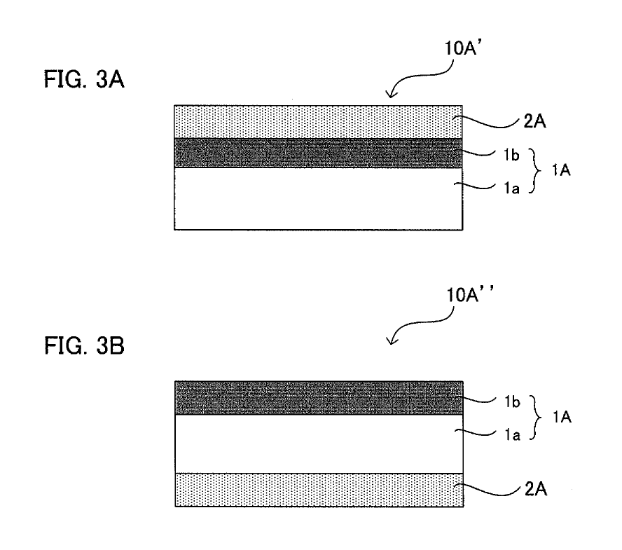

Such a formation embodiment of the retardation layer will be explained specifically with reference to the drawings. FIGS. 3A and 3B are each a schematic diagram showing an example of the embodiment of forming the retardation layer on the optically anisotropic film in this embodiment. As shown in FIGS. 3A and 3B, in the case the retardation films 10A′ and 10A″ of this embodiment have a configuration with an optically anisotropic film 1A having an optically anisotropic layer 1b formed on a transparent substrate 1a, and a retardation layer 2A formed on the optically anisotropic film 1A, the embodiment of forming the retardation layer 2A on the optically anisotropic film 1A may be: an embodiment formed on the optically anisotropic layer 1b (FIG. 3A), or an embodiment formed on the plane opposite to the side with the optically anisotropic layer 1b formed (FIG. 3B).

In this embodiment, any of the embodiments can be used preferably. Here, according to the embodiment of forming the retardation layer on the surface of the optically anisotropic layer side, since the optically anisotropic layer and the retardation layer are provided on the same side, continuous coating operation is facilitated so as to promote the production, the surface scattering of the optically anisotropic layer can be offset, and the surface of the opposite side of the transparent substrate can be revealed so that the revealed surface side can be laminated with a polarizer or it can be laminated with various functional layers such as a reflection preventing layer, and thus it is advantageous in that the freedom degree of the utilization method and the design specification can be expanded.

On the other hand, according to the embodiment forming the retardation layer on the surface on the opposite side of the plane with the optically anisotropic layer formed, owing to absence of the interaction between the retardation layer and the optically functional layer, deviation or irregularity from the designed value of the retardation as mentioned above can hardly be generated, and thus it is advantageous in that the desired optical characteristics can be provided easily to the retardation layer.

Therefore, a more suitable embodiment can be selected and used optionally out of the two embodiments according to the specific application, the required performance, the design policy, or the like of the retardation film of this embodiment.

### 3. Retardation Film

The retardation properties of the retardation film of this embodiment can be adjusted optionally according to the application of the retardation film of this embodiment. In particular, the Nz factor (Nz) of the retardation film of this embodiment is preferably in a range of −0.5 to 0.5, it is more preferably in a range of 0 to 0.3, and it is further preferably in a range of 0.15 to 0.4. Since the Nz factor is in the range, the retardation film of this embodiment can be provided with the excellent viewing angle compensating function of the liquid crystal display of the IPS system.

Here, the Nz factor (Nz) is a parameter showing the shape of the refractive index elliptic body of the retardation film of this embodiment represented by the following formula:

Nz={(Rth¹+Rth²)/(Re¹+Re²)}+0.5.

Rth¹ and Rth² mentioned above each represent the thickness direction out-of-plane retardation (Rth) of the optically anisotropic film and the retardation layer used in this embodiment.

Moreover, Re¹ and Re² mentioned above each represent the in-plane retardation (Re) of the optically anisotropic film and the retardation layer used in this embodiment.

In the formula, Rth¹ and Re¹ can be represented each by the following formulae with the premise that the refractive index of the slow axis direction in the in-plane direction of the optically anisotropic film to be used in this embodiment is nx₁, the refractive index of the fast axis direction in the in-plane direction is ny₁, the refractive index of the thickness direction is nz₁ and the thickness is d₁:

Rth¹={((nx₁+ny₁)/2)−nz₁}×d₁;

Re¹=(nx₁−ny₁)×d₁.

Moreover, in the formula, Rth² and Re² can be represented each by the following formulae with the premise that the refractive indices in the optional x and y directions orthogonal with each other in the in-plane direction of the retardation layer to be used in this embodiment are nx₂ and ny₂, the refractive index of the thickness direction is nz₂ and the thickness is d₂:

Rth²={((nx₂+ny₂)/2)−nz₂}×d₂;

Re²=(nx₂−ny₂)×d₂.

Moreover, the thickness of the retardation film of this embodiment is not particularly limited as long as it is in a range capable of having the retardation properties in a desired range. In particular, the thickness of the retardation film of this embodiment is preferably in a range of 20.5 μm to 220 μm, it is particularly preferably in a range of 25.5 μm to 145 μm, and it is further preferably in a range of 31 μm to 93 μm.

Since the compound made of the polymerizable rodlike molecule is contained in the first optically anisotropic material used for the optically anisotropic layer of the optically anisotropic film, the retardation film of this embodiment can achieve the desired retardation properties with a further thinner thickness.

The embodiment of the retardation film of this embodiment is not particularly limited. For example, it may either be of a sheet-like form matched to the screen size of the liquid crystal display to employ the retardation film of this embodiment or of a lengthy form.

### 4. Application of the Retardation Film

The retardation film of this embodiment can be used as a viewing angle compensating film, an elliptic polarizing plate, a luminance improving film, or the like to be used for the liquid crystal display. In particular, it can be used preferably as a viewing angle compensating film for the liquid crystal display of the IPS system.

In the case of using the retardation film of this embodiment as the viewing angle compensating film for the liquid crystal display, the retardation film of this embodiment can be used by itself, and furthermore, the retardation film of this embodiment can be used in a state laminated with another optically functional film. Furthermore, another adhesive retardation layer may be laminated directly on the plane opposite to the side with the adhesive retardation layer formed of the transparent substrate to be used for the retardation film of this embodiment.

As an example of using the retardation film of this embodiment in a state laminated with another optically functional film, for example, a case of using as a luminance improving film for the liquid crystal display by laminating a liquid crystal layer containing liquid crystal molecules of the cholesteric alignment onto the retardation film of this embodiment can be presented.

Moreover, the retardation film of this embodiment can also be used for the application as a polarizing plate by being attached with a polarizer. That is, the polarizing plate in general comprises a polarizer and polarizing plate protection films formed on its both surfaces. In this embodiment, for example by using the retardation film of this embodiment as one of the polarizing plate protection films, it can be used as a polarizing plate having the viewing angle compensating function of the liquid crystal display.

### 5. Production Method for the Retardation Film

Next, the production method for the retardation film of this embodiment will be explained. The production method for the retardation film of this embodiment is not particularly limited as long as it is a method capable of producing a retardation film having the above-mentioned configuration. As such a method, for example, following three methods can be presented.

The first method is a method comprising: an optically anisotropic film producing process of producing an optically anisotropic film by using a transparent substrate made of a cellulose derivative and applying an optically anisotropic layer forming coating solution containing a first optically anisotropic material onto the transparent substrate; a drawing process of drawing the optically anisotropic film produced in the optically anisotropic film producing process; and a retardation layer forming process of forming a retardation layer on the optically anisotropic layer by applying a retardation layer forming coating solution containing the second optically anisotropic material onto the optically anisotropic layer of the optically anisotropic film drawn by the drawing process. The retardation layer forming process may be for forming the retardation layer on the plane opposite to the surface with the optically anisotropic layer formed of the optically anisotropic film.

The second method is a method comprising: an optically anisotropic film producing process of producing an optically anisotropic film by using a transparent substrate made of a cellulose derivative and applying an optically anisotropic layer forming coating solution containing the first optically anisotropic material onto the transparent substrate; a retardation layer forming process of forming a retardation layer on the optically anisotropic layer by applying a retardation layer forming coating solution containing the second optically anisotropic material onto the optically anisotropic layer of the optically anisotropic film produced by the optically anisotropic film producing process; and a drawing process of drawing a laminated body of the optically anisotropic film and the retardation layer. The retardation layer forming process may be for forming the retardation layer on the plane opposite to the surface with the optically anisotropic layer formed of the optically anisotropic film.

The third method is a method comprising: an optically anisotropic film producing process of producing an optically anisotropic film by using a transparent substrate made of a cellulose derivative and applying an optically anisotropic layer forming coating solution containing the first optically anisotropic material onto the transparent substrate; a drawing process of drawing the optically anisotropic film produced in the optically anisotropic film producing process; and a retardation layer forming process of forming a retardation layer containing the second optically anisotropic material on a substrate comprising a vertical alignment film and adhering only the retardation layer on the optically anisotropic layer of the optically anisotropic film via an adhesive. The retardation layer forming process may be for forming the retardation layer on the plane opposite to the surface with the optically anisotropic layer formed of the optically anisotropic film.

The retardation film of this embodiment can be produced by any of the methods. In particular, according to the first method, a retardation film using the optically anisotropic film of the first embodiment can be obtained further simply.

Here, in the case of using a rodlike compound having a polymerizable functional group as the first optically anisotropic material in the first method and second method, a stable optically anisotropic layer can be formed by the polymerization process of the first optically anisotropic material. The timing of applying the polymerization process to the first optically anisotropic material may either be before or after the drawing process.

As to the device used for the drawing process, the processing method, or the like, the drawing operation can be carried out with the optional conditions using basically the same device used for an ordinary synthetic resin film drawing process in consideration to the constituent materials of the optically anisotropic film, and the desired retardation value.

As to the drawing operation, either the uniaxial drawing treatment or the biaxial drawing treatment may be carried out. Moreover, as the biaxial drawing treatment, the unbalanced-biaxial drawing treatment may be executed. According to the unbalanced-biaxial drawing, a polymer film is drawn to a certain magnification in one direction, and it is further drawn to the magnification more than that in the direction perpendicular thereto. The two direction drawing treatments may be executed at the same time. In particular, in this embodiment, it is preferable to carry out the uniaxial drawing.

Moreover, the drawing method used in this process is not particularly limited as long as it is a method capable of drawing the optically anisotropic film to a desired drawing magnification. As the drawing method to be used in this process, for example, the roll drawing method, the long gap drawing method, the tenter drawing method, or the tubular drawing method can be presented. In the case of carrying out the drawing process by the roll to roll process, the embodiment of the drawing treatment may be an embodiment of drawing in the parallel direction with respect to the film conveyance direction (vertical drawing) or an embodiment of drawing in the direction substantially perpendicular to the film conveyance direction (lateral drawing) For the roll to roll attachment with the polarizer, the tenter drawing method is preferable.

In this process, the drawing magnification of drawing the optically anisotropic film is not particularly limited as long as the desired optically anisotropic properties can be provided to the optically anisotropic film. In particular, in this process, it is preferably in a range of 1.01 times to 1.4 times, it is particularly preferably in a range of 1.1 times to 1.4 times, and it is further preferably in a range of 1.15 times to 1.35 times.

Additionally, as to the specific executing method of each process in the methods, since the methods used commonly at the time of producing a retardation film for the liquid crystal display can be used, detailed explanation is not repeated here.

### A-2: Retardation Film of the Second Embodiment

Next, a retardation film of the second embodiment will be explained. A retardation film of the present embodiment comprises: an optically anisotropic film having; a transparent substrate made of a cellulose derivative, and an optically anisotropic layer, formed on the transparent substrate, containing the cellulose derivative for comprising the transparent substrate, and an optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and

a retardation layer, formed on the optically anisotropic film, containing a liquid crystal material with a homeotropic orientation formed, in which refractive indices nx₂ and ny₂ of optional x and y directions orthogonal with each other in the in-plane direction and a refractive index nz₂ of a thickness direction satisfy the formula of nx₂≦ny₂<nz₂, wherein a Nz factor (Nz) is in a range of −0.5<Nz<0.5, and an in-plane retardation (Re) is in a range of 50 nm<Re<170 nm.

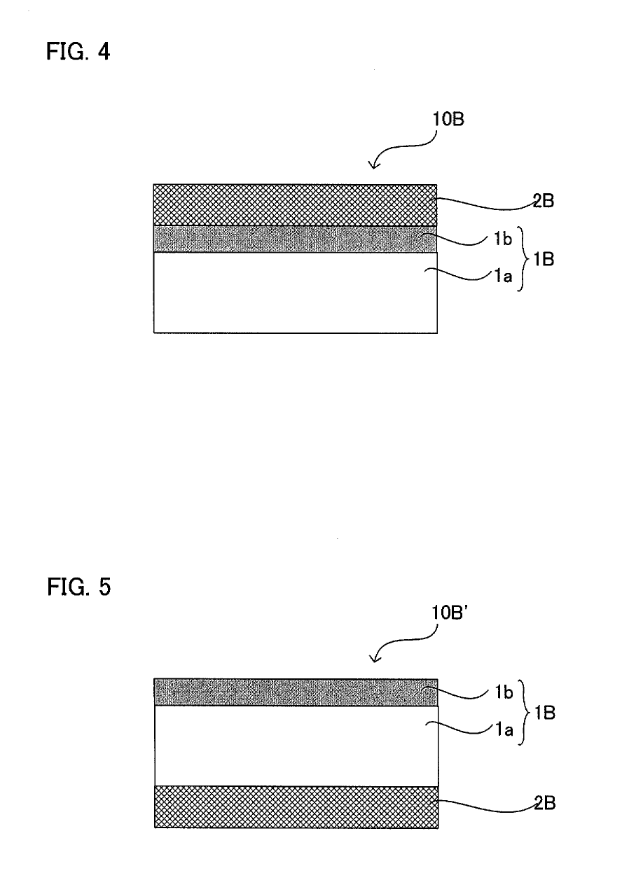

The retardation film of this embodiment will be explained with reference to the drawings. FIG. 4 is a schematic diagram showing an example of the retardation film of this embodiment. As shown in FIG. 4, the retardation film 10B of this embodiment comprises an optically anisotropic film 1B having a transparent substrate 1a made of a cellulose derivative and an optically anisotropic layer 1b formed on the transparent substrate 1a, and a retardation layer 2B formed on the optically anisotropic layer 1b of the optically anisotropic film 1B, in which the Nz factor (Nz) of the entire retardation film 10B is in a range of −0.5<Nz<0.5, and the in-plane retardation (Re) is in a range of 50 nm<Re<170 nm.

Here, the optically anisotropic film 1B contains a cellulose derivative comprising the transparent substrate 1a, and an optically anisotropic material showing the normal dispersion type wavelength dependency of the retardation in the optically anisotropic layer 1b, in which the optically anisotropic film 1B as a whole has the optical characteristics satisfying the formula of nx₁>ny₁ with premise that the refractive index of the slow axis direction in the in-plane direction is nx₁ and the refractive index of the fast axis direction in the in-plane direction is ny₁.

Moreover, the retardation layer 2B contains a liquid crystal material with the homeotropic orientation formed, and the retardation layer 2B as a whole has the optical characteristics satisfying the formula of nx₂≦ny₂<nz₂, in which the refractive indices in the optional x and y directions orthogonal with each other in the in-plane direction are nx₂ and ny₂ and the refractive index of the thickness direction is nz₂.

Here, although an example of the retardation layer formed on the optically anisotropic layer of the optically anisotropic film has been explained with reference to FIG. 1, the explanation is merely an example so that the configuration of the retardation film of this embodiment is not limited to that shown in FIG. 1. Therefore, the retardation film of this embodiment may have the retardation layer 2B formed for example on the transparent substrate 1a of the optically anisotropic film 1B as shown in FIG. 5.

According to this embodiment, since the optically anisotropic film has the configuration with the optically anisotropic layer containing the optically anisotropic material laminated on the transparent substrate made of the cellulose derivative, and the retardation layer contains the liquid crystal material with the homeotropic orientation alignment formed, for example by changing factors such as the thickness of the optically anisotropic layer or the retardation layer, the optical characteristics of the retardation film as a whole can be adjusted in a predetermined range. Moreover, since the optically anisotropic material contained in the optically anisotropic layer and the liquid crystal material contained in the retardation layer both show the excellent refractive index anisotropic properties, a wide range of the optical characteristics can be realized by this embodiment.

Moreover, according to this embodiment, since desired optical characteristics can be realized without containing a hydrophobic compound in the transparent substrate, the adhesion properties of the transparent substrate with respect to a hydrophilic polarizer cannot be deteriorated. Therefore, according to this embodiment, a retardation film having the excellent adhesion properties to a polarizer can be obtained.

Furthermore, according to the retardation film of this embodiment, since the Nz factor and the in-plane retardation are in the above-mentioned ranges, the excellent viewing angle compensating function of the liquid crystal display of the IPS system can be provided.

Moreover, according to this embodiment, since one having the transparent substrate made of a cellulose derivative is used as the optically anisotropic film, in the case of using the retardation film of this embodiment for the inner side polarizing plate protection film, a polarizing plate protection film made of a cycloolefin resin can be used for the outer side polarizing plate protection film so that a polarizing plate with the excellent endurance can be obtained.

Accordingly, in the present embodiment, a retardation film to be used preferably as a viewing angle compensating film for the liquid crystal display of the IPS system, with a wide range of the realizable optical characteristics, having the excellent adhesion properties to the polarizer, and also having, the easy adjusting properties for the optical characteristics can be obtained.

The Nz factor (Nz) is a parameter showing the shape of the refractive index elliptic body of the retardation film of this embodiment represented by the following formula:

Nz={(Rth¹+Rth²)/(Re¹+Re²)}+0.5.

Here, Rth¹ and Rth² mentioned above each represent the out-of-plane direction retardation (Rth) of the optically anisotropic film and the retardation layer used in this embodiment.

Moreover, Re¹ and Re² mentioned above each represent the in-plane retardation (Re) of the optically anisotropic film and the retardation layer used in this embodiment.

In the formula, Rth¹ and Re¹ can be represented each by the following formulae with the premise that the refractive index of the slow axis direction in the in-plane direction of the optically anisotropic film to be used in this embodiment is nx₁, the refractive index of the fast axis direction in the in-plane direction is ny₁, the refractive index of the thickness direction is nz₁ and the thickness is d₁:

Rth¹={((nx₁+ny₁)/2)−nz₁}×d₁;

Re¹=(nx₁−ny₁)×d₁.

Moreover, in the formula, Rth² and Re² can be represented each by the following formulae with the premise that the refractive indices in the optional x and y directions orthogonal with each other in the in-plane direction of the retardation layer to be used in this embodiment are nx₂ and ny₂, the refractive index of the thickness direction is nz₂ and the thickness is d₂:

Rth²={((nx₂+ny₂)/2)−nz₂}×d₂;

Re²=(nx₂−ny₂)×d₂.

Furthermore, according to this embodiment, the optically anisotropic layer includes the optically anisotropic material having the wavelength dependency of the retardation value of the normal dispersion type. In this embodiment, the “normal dispersion type” denotes a type of the wavelength dependency with the ratio (Re₄₅₀/Re₅₅₀) of the in-plane retardation at the 450 nm wavelength (Re₄₅₀) and the in-plane retardation at the 550 nm wavelength (Re₅₅₀) of more than 1 (hereafter, it may be referred to simply as the “Re ratio”).

In this embodiment, a type of the wavelength dependency with the Re ratio of less than 1 is referred to as the “anomalous dispersion type”, and a type of the wavelength dependency with the Re ratio of 1 is referred to as the “flat type”.

Moreover, the in-plane retardation and the out-of-plane direction retardation in this embodiment denote values with respect to the 550 nm wavelength unless the wavelength is specified otherwise.

The retardation film of this embodiment comprises at least the optically anisotropic film and the retardation layer.

Hereafter, each configuration used in the retardation film of this embodiment will be explained in detail.

### 1. Optically Anisotropic Film

First, the optically anisotropic film used in this embodiment will be explained. The optically anisotropic film used in this embodiment comprises: a transparent substrate made of a cellulose derivative, and an optically anisotropic layer, formed on the transparent substrate containing the cellulose derivative for comprising the transparent substrate and an optically anisotropic material showing the normal dispersion type wavelength dependency of the retardation, in which the refractive index nx₁ of the slow axis direction in the in-plane direction and the refractive index ny₁ of the fast axis direction in the in-plane direction satisfy the formula of nx₁>ny₁.

Hereafter, such an optically anisotropic film will be explained in detail.

### (1) Optically Anisotropic Layer

First, the optically anisotropic layer used in this embodiment will be explained. The optically anisotropic layer used in this embodiment is formed on the transparent substrate to be described later and contains: a cellulose derivative comprising the transparent substrate, and an optically anisotropic material showing the normal dispersion type wavelength dependency of the retardation.

a. Optically Anisotropic Material

The optically an isotropic material used in this embodiment is not particularly limited as long as its wavelength dependency of the retardation is of the normal dispersion type so that one capable of providing a desired retardation properties to the retardation film of this embodiment may be selected and used optionally according to factors such as the application of the retardation film of this embodiment. In particular, it is preferable that the optically anisotropic material used in this embodiment has the Re ratio in a range of 1 to 2.

Here, the Re ratio of the optically anisotropic material can be calculated by forming a layer of the optically anisotropic material on an isotropic base material such as a glass substrate with an alignment film of polyimide, or the like formed and the alignment process applied, and measuring Re at the 450 nm wavelength (Re₄₅₀) and the 550 nm wavelength (Re₅₅₀).

As the optically anisotropic material to be used in this embodiment, it is preferable to use a rodlike compound among those having the Re ratio in the above-mentioned range. Since the rodlike compound can realize the excellent retardation properties by the regular alignment, by use of such a rodlike compound, desired retardation properties can be provided to the optically anisotropic film easily.

Here, the “rodlike compound” in this embodiment denotes a compound with the principal skeleton of the molecular structure of a rodlike form.

As the rodlike compound in this embodiment, a compound having a relatively small molecular weight is preferable. More specifically, a compound having a molecular weight in a range of 200 to 1,200 is preferable, and a compound having a molecular weight in a range of 400 to 1,000 can be used preferably. The reason thereof is as follows. The optically anisotropic layer used in this embodiment contains the optically anisotropic material and the cellulose derivative comprising the transparent substrate to be described later. Since a compound having a relatively small molecular weight is used as the rodlike compound, the rodlike compound can be mixed easily with the cellulose derivative in the optically anisotropic layer so that the adhesion between the transparent substrate and the optically anisotropic layer can be improved.

In the case of using one having a polymerizable functional group is used as the rodlike compound, the molecular weight of the rodlike compound denotes the molecular weight of the monomer before the polymerization.

Moreover, it is preferable that the rodlike compound used in this embodiment is a liquid crystal material showing the liquid crystalline properties. Since the liquid crystal material has the characteristics to be regularly aligned, owing to the large birefringence Δn (nx−ny), the desired retardation properties can easily be provided.

As the liquid crystal material, any material showing any liquid crystal phase such as the nematic phase, the cholesteric phase, the smectic phase, or the like can be used preferably. In particular, in this embodiment, it is preferable to use a liquid crystal material showing the nematic phase because the liquid crystal material showing the nematic phase facilitates the better-regular alignment compared with a liquid crystal material showing the other liquid crystal phases.

Moreover, as the liquid crystal material showing the nematic phase, it is preferable to use a material having a spacer at the mesogen both ends. Since a liquid crystal material having a spacer at the mesogen both ends has the excellent flexibility, by use of such liquid crystal material, the optically anisotropic film to be used in this embodiment can be provided with the excellent transparency.

Furthermore, as the rodlike compound to be used in this embodiment, those having a polymerizable functional group in a molecule can be used preferably. In particular, those having a three-dimensionally cross-linkable polymerizable functional group can be used further preferably. Since the rodlike compound has a polymerizable functional group, the rodlike compound can be polymerized and fixed so that the optically anisotropic layer with the excellent alignment stability without the aging change in the retardation properties can be obtained.

Moreover, in this embodiment, the rodlike compound having a polymerizable functional group and the rodlike compound not having a polymerizable functional group can be used as a mixture.

The “three-dimensional cross-linking” denotes the three-dimensional polymerization of the liquid crystalline molecules with each other so as to be in a state of the network structure.

Since the polymerizable functional group is same as that explained as the polymerizable functional group used for the first optically anisotropic material in the item of “A-1: Retardation film of the first embodiment”, explanation is not repeated here.

Furthermore, it is particularly preferable that the rodlike compound is a liquid crystal material showing the liquid crystal properties having the polymerizable functional group at the end. Since such a liquid crystal material is used, for example by the three-dimensional polymerization with each other, it is in a state of the network structure so that the optically anisotropic layer having the alignment stability and the excellent optical characteristic realizing properties can be formed.

In this embodiment, even in the case of using a liquid crystal material having a polymerizable functional group at one end, the alignment stabilization can be achieved by cross-linking with the other molecules.

As the specific examples of the rodlike compound to be used in this embodiment, the compounds represented by the above-mentioned formulae (24) to (29) can be presented.

Moreover, as the specific examples of the nematic liquid crystal material having an acrylate group at the end, those represented by the above-mentioned formulae (30) to (40) can be presented.

The liquid crystal material to be used in this embodiment may either be only one kind or two or more kinds. For example in the case as the liquid crystal material, a liquid crystal material having one or more polymerizable functional groups at both ends and a liquid crystal material having one or more polymerizable functional groups at one end are used as a mixture, according to the adjustment of the composition ratio thereof, the polymerization density (cross-linking density) and the optical characteristics can be adjusted optionally, and thus it is preferable.

b. Cellulose Derivative

Next, the cellulose derivative contained in the optically anisotropic layer to be used in this embodiment will be explained. The cellulose derivative used in this embodiment is a cellulose derivative comprising the transparent substrate to be described later. In this embodiment, since such a cellulose derivative is contained in the optically anisotropic layer, an optically anisotropic film having the excellent adhesion properties between the transparent substrate and the optically anisotropic layer can be obtained.

The amount of the cellulose derivative contained in the optically anisotropic layer in this embodiment is not particularly limited as long as the adhesion properties between the transparent substrate and the optically anisotropic layer can be provided in a desired range in the optically anisotropic film used in this embodiment. In particular, in this embodiment, the content of the cellulose derivative is preferably in a range of 1% by mass to 50% by mass, and it is particularly preferably in a range of 5% by mass to 30% by mass.

Since the cellulose derivative contained in the optically anisotropic layer is same as that to be explained as the cellulose derivative comprising the transparent substrate in the item of “(2) Transparent substrate” to be described later, explanation is not repeated here.

c. Optically Anisotropic Layer

The optically anisotropic layer used in this embodiment may contain compounds other than the optically anisotropic material and the cellulose derivative. Since such another compound is same as those explained as the other compounds used for the optically anisotropic layer in the item of “A-1: Retardation film of the first embodiment”, explanation is not repeated here.

The thickness of the optically anisotropic layer used in this embodiment is not particularly limited as long as it is in a range capable of having the optical characteristics of the optically anisotropic film used in this embodiment at a desired value according to the kind of the optically anisotropic material or the kind of the transparent substrate to be described later. In particular, in this embodiment it is preferably in a range of 0.5 μm to 20 μm.

### (2) Transparent Substrate

Next, the transparent substrate used for the optically anisotropic film in this embodiment will be explained. The transparent substrate used in this embodiment is made of a cellulose derivative. Here, since the transparent substrate to be used in this embodiment is same as those explained in the item of “A-1: Retardation film of the first embodiment”, explanation is not repeated here.

### (3) Optically Anisotropic Film

The optically anisotropic film used in this embodiment has the formula of nx₁>ny₁ satisfied between the refractive index nx₁ of the slow axis direction in the in-plane direction and the refractive index ny₁ of the fast axis direction in the in-plane direction. Therefore, the optically anisotropic film used in this embodiment has the properties as the so-called A plate or B plate.

Here, as the embodiment satisfying the formula of nx₁>ny₁, the embodiments satisfying the formulas of nx₁>ny₁>nz₁, nx₁>nz₁>ny₁, nx₁>ny₁=nz₁, and nz₁>nx₁>ny₁ can be presented. As the optically anisotropic film used in this embodiment, one satisfying any of these formulae can be used preferably.

Re¹ of the optically anisotropic film used in this embodiment is not particularly limited as long as it is in a range capable of having the Nz factor and the in-plane retardation of the retardation film of this embodiment in a range defined in this embodiment so that it can be adjusted optionally according to factors such as the application of the retardation film of this embodiment. In particular, in this embodiment, Re¹ of the optically anisotropic film is preferably in a range of 50 nm<Re¹<170 nm, and it is particularly preferably in a range of 70 nm<Re¹<150 nm. Since Re¹ is in such a range, the retardation film of this embodiment can be provided with the further superior viewing angle compensating function of the liquid crystal display of the IPS system.

Moreover, the wavelength dependency of Re¹ of the optically anisotropic film used in this embodiment may be any of the inverse anomalous dispersion type, the normal dispersion type and the flat dispersion type.

Moreover, the Nz factor (Nz¹) of the optically anisotropic film used in this embodiment is not particularly limited as long as it is in a range capable of providing the Nz factor of the retardation film of this embodiment in a range defined in this embodiment. In particular, in this embodiment, the Nz factor (Nz¹) of the optically anisotropic film is preferably in a range of 1.0 to 3.0, and it is particularly preferably in a range of 1.0 to 2.0. Since the Nz factor (Nz¹) is in such a range, the retardation film of this embodiment can be provided with the further superior viewing angle compensating function of the liquid crystal display of the IPS system.

Since the Nz factor (Nz¹) of the optically anisotropic film is same as that explained in the item of “A-1: Retardation film of the first embodiment”, explanation is not repeated here.

The optically anisotropic film used in this embodiment has the configuration with the optically anisotropic layer formed so as to be adhered on the transparent substrate. The adhesion degree of the optically anisotropic layer and the transparent substrate at the time is not particularly limited as long as it is in a range capable of controlling the dynamic characteristics of the optically anisotropic layer by the dynamic characteristics of the transparent substrate. In particular, in this embodiment, the adhesion degree is preferably in a range of 20/100 to 100/100 by the evaluation result of the cross cut method.

Since the “cross cut method” and the evaluation method thereof are same as those explained in the item of “A-1: Retardation film of the first embodiment”, explanation is not repeated here.

Moreover, in the optically anisotropic film used in this embodiment, the embodiment with the transparent substrate and the optically anisotropic layer laminated may be either an embodiment with the transparent substrate and the optically anisotropic layer laminated as the individual layers, or an embodiment without a clear interface between the transparent substrate and the optically anisotropic layer laminated with the content of the optically anisotropic material changed continuously there between. Since the embodiments are same as the embodiment presented in FIGS. 2A and 2B mentioned above, detailed individual explanation is not repeated here.

### 2. Retardation Layer

Next, the retardation layer to be used in this embodiment will be explained. The retardation layer to be used in this embodiment contains a liquid crystal material with the homeotropic orientation formed, in which the refractive indices nx₂ and ny₂ in the optional x and y directions orthogonal with each other in the in-plane direction and the refractive index nx₂ of the thickness direction nz₂ satisfy the formula of ≦ny₂<nz₂

Hereafter, the retardation layer to be used in this embodiment will be explained.

### (1) Liquid Crystal Material

First, the liquid crystal material to be used for this embodiment will be explained. The liquid crystal material to be used for this embodiment is not particularly limited as long as it is a homeotropic liquid crystal material capable of forming the homeotropic orientation and capable of providing the retardation properties satisfying the above-mentioned formula regarding nx₂, ny₂ and nz₂. Since the same one explained in the item of “A-1: Retardation film of the first embodiment” can be used as such a homeotropic liquid crystal material, explanation is not repeated here.

### (2) Other Compounds

The retardation layer to be used in this embodiment may contain compounds other than the liquid crystal material. The other compound is not particularly limited as long as it does not deteriorate the sequence state of the liquid crystal material in the retardation layer or the optical characteristic realizing properties of the retardation layer so that it can be selected and used optionally according to factors such as the application of the retardation film of this embodiment.

Here, since the other compounds to be used in this embodiment are same as those explained as the other compounds used for the retardation layer in the item of “A-1: Retardation film of the first embodiment”, explanation is not repeated here.

### (3) Retardation Layer

The retardation layer to be used in this embodiment has the formula of nx₂≦ny₂<nz₂ with premise that the refractive indices in the optional x and y directions orthogonal with each other in the in-plane direction are nx₂, ny₂ and the refractive index of the thickness direction is nz₂ satisfying. Therefore, the retardation layer to be used in this embodiment has the properties as the so-called positive C plate.

The retardation (Rth²) in the out-of-plane direction of the retardation layer to be used in this embodiment is not particularly limited as long as it is in a range capable of having the Nz factor of the retardation film of this embodiment in a range defined in this embodiment. In particular, in this embodiment, it is preferable that Rth² mentioned above is in a range of −270 nm to −50 nm. Since Rth² mentioned above is in the range, the retardation film of this embodiment can be provided with the excellent viewing angle compensating function of the liquid crystal display of the IPS system.

Here, Rth² mentioned above can be measured by for example, the parallel nicol rotation method using KOBRA-WR produced by Oji Scientific Instruments.

The thickness of the retardation layer in this embodiment is not particularly limited as long as it is in a range capable of providing the desired optical characteristics to the retardation layer according to factors such as the kind of the liquid crystal material. It is preferably in a range of 0.5 μm to 10 μm, it is more preferably in a range of 0.5 μm to 5 μm, and it is particularly preferably in a range of 1 μm to 3 μm.

The retardation layer to be used in this embodiment is formed on the optically anisotropic film. As to the embodiment of forming the retardation layer on the optically anisotropic film in this embodiment, it may be an embodiment of forming on the optically anisotropic layer of the optically anisotropic film or it may be an embodiment of forming on the transparent substrate of the optically anisotropic film.

### 3. Retardation Film

The retardation film of this embodiment has the Nz factor (Nz) in a range of −0.5<Nz<0.5, and the in-plane retardation (Re) in a range of 50 nm<Re<170 nm.

Moreover, the retardation film of this embodiment may have the Nz factor (Nz) a range of −0.5<Nz<0.3.

The Nz factor (Nz) of the retardation film of this embodiment is not particularly limited as long as it is in the range so that it may be adjusted optionally according to the specific application of the retardation film of this embodiment. In particular, in this embodiment, it is preferable that the Nz factor (Nz) is in a range of 0.0 to 0.5. Since the Nz factor (Nz) is in the range, the retardation film of this embodiment can be provided with the further superior viewing angle compensating function of the liquid crystal display of the IPS system.

Moreover, the in-plane retardation (Re) of the retardation film of this embodiment is not particularly limited as long as it is in the range so that it may be adjusted optionally according to the specific application of the retardation film of this embodiment. In particular, in this embodiment, it is preferable that the in-plane retardation (Re) is in a range of 70 nm<Re<150 nm.

The embodiment of the retardation film of this embodiment is not particularly limited. For example, it may either be of a sheet-like form matched to the screen size of the liquid crystal display to employ the retardation film of this embodiment or of a lengthy form.

### 4. Application of the Retardation Film

Since the application of the retardation film of this embodiment is same as that explained in the item of “A-1: Retardation film of the first embodiment”, explanation is not repeated here.

### 5. Production Method for the Retardation Film

Next, the production method for the retardation film of this embodiment will be explained. The production method for the retardation film of this embodiment is not particularly limited as long as it is a method capable of producing a retardation film having above-mentioned the configuration. As such a method, for example, following three methods can be presented.

The first method is a method comprising: an optically anisotropic film producing process of producing an optically anisotropic film by using a transparent substrate made of a cellulose derivative and applying an optically anisotropic layer forming coating solution containing an optically anisotropic material onto the transparent substrate;, a drawing process of drawing the optically anisotropic film produced in the optically anisotropic film producing process; and a retardation layer forming process of forming a retardation layer on the optically anisotropic layer by applying a retardation layer forming coating solution containing the liquid crystal material onto the optically anisotropic layer of the optically anisotropic film drawn by the drawing process.

The second method is a method comprising: an optically anisotropic film producing process of producing an optically anisotropic film by using a transparent substrate made of a cellulose derivative and applying an optically anisotropic layer forming coating solution containing the optically anisotropic material onto the transparent substrate; a retardation layer forming process of forming a retardation layer on the optically anisotropic layer by applying a retardation layer forming coating solution containing the liquid crystal material onto the optically anisotropic layer of the optically anisotropic film produced by the optically anisotropic film producing process; and a drawing process of drawing a laminated body of the optically anisotropic film and the retardation layer.

The third method is a method comprising: an optically anisotropic film producing process of producing an optically anisotropic film by using a transparent substrate made of a cellulose derivative and applying an optically anisotropic layer forming coating solution containing the optically anisotropic material onto the transparent substrate; a drawing process of drawing the optically anisotropic film produced in the optically anisotropic film producing process; and a retardation layer forming process of forming a retardation layer containing the liquid crystal material on a substrate comprising a vertical alignment film and adhering only the retardation layer on the optically anisotropic layer of the optically anisotropic film via an adhesive.

The retardation film of this embodiment can be produced by any of the methods. In particular, according to the first method, a retardation film using the optically anisotropic film of the first embodiment can be obtained further simply.

Here, although an example of forming the retardation layer on the optically anisotropic film of the optically anisotropic film has been explained in the first to third methods, the retardation layer may be formed on the transparent substrate of the optically anisotropic film in the first to third methods.

Since the device, the processing method, or the like used for the drawing process are same as those explained in the item of “A-1: Retardation film of the first embodiment”, explanation is not repeated here.

Furthermore, the drawing magnification of the drawing treatment is not particularly limited so as to be determined optionally according to the retardation value to be obtained. In terms of evenly having the retardation values at each point in the in-plane direction of the film, it is preferably in a range of 1.03 to 2 times.

Additionally, as to the specific executing method of each process in the methods, since the methods used commonly at the time of producing a retardation film for the liquid crystal display can be used, detailed explanation is not repeated here.

### B. Polarizing Plate

Next, the polarizing plate of the present invention will be explained. The polarizing plate of the present invention is the retardation film of the first embodiment of the present invention used as a polarizing plate protection film.

That is, the polarizing plate of the present invention comprises the retardation film of the first embodiment of the present invention, a polarizer formed on the optically anisotropic film of the retardation film, in which the polarizer is formed plane on the opposite to the side with the retardation layer, and a polarizing plate protection film formed on the polarizer.

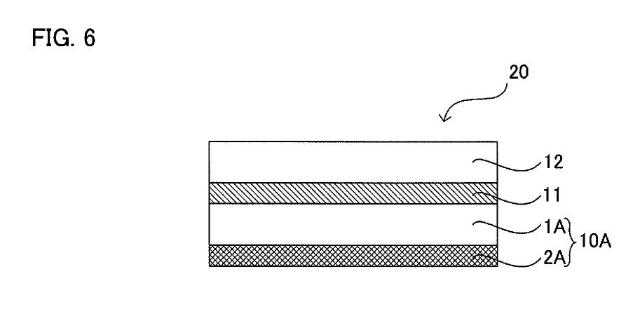

Such a polarizing plate of the present invention will be explained with reference to the drawings. FIG. 6 is a schematic diagram showing an example of the polarizing plate of the present invention. As shown in FIG. 6, the polarizing plate 20 of the present invention comprises a retardation film 10A, a polarizer 11 formed on an optically anisotropic film 1A of the retardation film 10A, and a polarizing plate protection film 12 formed on the polarizer 11.

In such an example, the polarizing plate 20 of the present invention utilizes the retardation film 10A of the first embodiment of the present invention as the retardation film 10A.

According to the present invention, since the retardation film of the first embodiment of the present invention is used as one of the polarizing plate protection films, a polarizing plate with the excellent endurance and the viewing angle compensating function of the liquid crystal display of the IPS system can be obtained.

The polarizing plate of the present invention comprises at least the retardation film, a polarizer and a polarizing plate protection film.

Hereafter, each configuration used in the polarizing plate of the present invention will be explained.

Since the retardation film used in the present invention is same as that explained in the item “A. Retardation film A-1: Retardation film of the first embodiment”, explanation is not repeated here.

### 1. Polarizing Plate Protection Film

First, the polarizing plate protection film used in the present invention will be explained. The polarizing plate protection film used in the present invention has the function of preventing exposure of the polarizer to the moisture content in the air, or the like in the polarizing plate of the present invention, and the function of preventing the size change of the polarizer.

The polarizing plate protection film to be used in the present invention is not particularly limited as long as the polarizer can be protected in the polarizing plate of the present invention and it has a desired transparency. In particular, the transmittance in the visible light range of the polarizing plate protection film to be used in the present invention is preferably 80% or more, and it is more preferably 90% or more.

Here, the transmittance of the polarizing plate protection film can be measured by the JIS K7361-1 (testing method of the total light transmittance of the plastic-transparent materials).

As the material for the polarizing plate protection film to be used in the present invention, for example, a cellulose derivative, a cycloolefin based resin, polymethyl methacrylate, polyvinyl alcohol, polyimide, polyallylate, polyethylene terephthalate, polysulfone, polyether sulfone, amorphous polyolefin, modified acrylic based polymer, polystyrene, an epoxy resin, polycarbonate, polyesters, or the like can be presented.

In particular, in the present invention, it is preferable to use a cellulose derivative or a cycloolefin based resin as the resin material.

As the cellulose derivative, for example, the same ones explained as the cellulose derivative comprising the transparent substrate to be used for the optically anisotropic film in the item of “A. Retardation film A-1: Retardation film of the first embodiment” can be used.

On the other hand, the cycloolefin based resin is not particularly limited as long as it is a resin having a monomer unit of a cyclic olefin (cycloolefin). As such a monomer of the cyclic olefin, for example, norbornen, polycyclic norbornen based monomer, or the like can be presented.

Moreover, as the cycloolefin based resin to be used in the present invention, either cycloolefin polymer (COP) or cycloolefin copolymer (COC) can be used preferably.

The cycloolefin based resin to be used in the present invention may either be a single monomer or a polymer of the cyclic olefin.

Moreover, the cycloolefin based resin to be used in the present invention preferably has the saturated moisture absorption ratio at 23° C. of 1% by mass or less, and particularly preferably in a range of 0.1% by mass to 0.7% by mass. Since such a cycloolefin based resin is used, the optical characteristic change or the size change by the moisture absorption of the polarizing plate of the present invention can further be prevented.

Here, the saturated moisture absorption ratio can be obtained by measuring the weight increase after impregnation in the 23° C. water for 1 week based on the ASTMD570.

Furthermore, as the cycloolefin based resin to be used in the present invention, those having a glass transition point in a range of 100° C. to 200° C., particularly preferably in a range of 100° C. to 180° C., and further preferably in a range of 100° C. to 150° C. Since the glass transition point is in the range, the polarizing plate of the present invention can be provided with the further superior heat resistance and process suitability.

As the specific examples of the polarizing plate protection film made of the cycloolefin based resin to be used in the present invention, for example, Topas produced by Ticona GmBH, Arton produced by JSR Corporation, ZEONOR produced by ZEON CORPORATION, ZEONEX produced by ZEON CORPORATION, Apel produced by Mitsui Chemicals Inc., or the like can be presented.

As the polarizing plate protection film to be used in the present invention, either those made of the cellulose derivative or those made of the cycloolefin based resin can be used preferably. In particular, in the present invention, it is preferable to use those made of the cycloolefin based resin. The reason is as follows. The polarizing plate of the present invention employs the retardation film of the first embodiment of the present invention as one of the polarizing plate protection films, and the retardation film uses an optically anisotropic film using a transparent substrate made of the cellulose derivative. Therefore, if one made of the cellulose derivative is used for the polarizing plate protection film, the polarizing plate protection films on the both surfaces in the polarizing plate of the present invention are made of the cellulose derivative, and as a result, the endurance of the optical characteristics, or the like may be deteriorated.

In this regard, by use of a polarizing plate protection film made of the cycloolefin based resin or an acrylic based resin, the retardation film of the first embodiment of the present invention with the polarizing plate protection film made of the cycloolefin based resin or the acrylic based resin used on one side and the cellulose derivative used on the other side is used in the polarizing plate of the present invention so that the concern mentioned above can be lowered.

The configuration of the polarizing plate protection film used in the present invention is not limited to the configuration comprising a single layer, but it may have a configuration with a plurality of layers laminated.

Moreover, in the case of the configuration with a plurality of layers laminated, layers of the same composition may be laminated, or a plurality of layers of different compositions may be laminated.

### 2. Polarizer

Next, the polarizer to be used in the present invention will be explained. The polarizer to be used in the present invention has the function of providing the polarizing characteristics to the polarizing plate of the present invention.

The polarizer to be used in the present invention is not particularly limited as long as the desired polarizing characteristics can be provided to the polarizing plate of the present invention so that those commonly used for the polarizing plate of the liquid crystal display can be used without any limitation. In the present invention, as such a polarizer, in general, a polarizer produced by drawing a polyvinyl alcohol film, containing iodine can be used.

### 3. Production Method for the Polarizing Plate

The production method for the polarizing plate of the present invention is not particularly limited as long as it is a method capable of producing a polarizing plate having the above-mentioned configuration. As such a method, in general, a method of attaching the polarizing plate protection film and the retardation film to the polarizer via an adhesive can be used.

Moreover, the retardation film and the polarizer are attached in general such that the slow axis direction of the retardation film and the absorption axis direction of the polarizer are orthogonal with each other.

As the method of attaching the polarizing plate protection film, the retardation film and the polarizer, the methods used commonly at the time of producing the polarizer to be used for the liquid crystal display can be used. As such a method, for example, the method disclosed in the official gazette of the Japanese Patent No. 3,132,122, or the like can be used.

Moreover, in the case of industrially producing the polarizing plate of the present invention, in general, a method of producing a polarizing plate in a form taken up as a roll by attaching a polarizer, a polarizing plate protection film and a retardation film formed lengthily and attaching the same in the lengthy state is used. In the case of producing the polarizing plate of the present invention by such a method, by use of one having the absorption axis direction parallel to the longitudinal direction as the polarizer and one having the slow axis direction perpendicular to the longitudinal direction as the retardation film, the polarizing plate of the present invention can be produced efficiently by the roll to roll process.

In a preferable use-embodiment of the polarizing plate of the present invention, the retardation film is disposed on the liquid crystal cell side and the polarizing plate protection film on the side opposite to the liquid crystal cell. By use of the embodiment, the endurance of the polarizing plate and the moisture content exhaustion at the time of producing the polarizing plate can be realized at the same time.

The present invention is not limited to the above-mentioned embodiments. The embodiments are examples so that anyone having the substantially same configuration as the technological idea mentioned in the scope of the claims of the present invention and the same effects is incorporated in the technological range of the present invention.

### EXAMPLES

Next, the present invention will be explained further specifically with reference to the examples.

### 1. Example 1

### (1) Production of the Optically Anisotropic Film

An optically anisotropic layer forming coating solution was prepared by dissolving a polymerizable liquid crystal compound represented by the following formula (A) (number of the carbon atoms in the alkyl chain: 6) in cyclohexanone by 20% by mass, and further adding a photo polymerization initiating agent by 4% by mass with respect to the solid component.

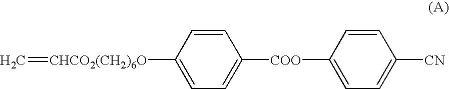

Then, using a triacetyl cellulose film (hereafter, referred to as a TAC film) (product name: TF80UL produced by FUJIFILM Corporation) as the transparent substrate, the optically anisotropic layer forming coating solution was applied to the surface of the transparent substrate by bar coating so as to have the coating amount after drying of 2.5 g/m².

Subsequently, an optically laminated body was formed by fixing the photo polymerizable liquid crystal compound by drying and eliminating the solvent while heating at 60° C. for 4 minutes and directing the ultraviolet ray to the coating surface.

An optically anisotropic film was produced by the uniaxial drawing of the optically laminated body with a drawing experiment machine so as to have the drawing magnification of 1.2 times while heating at 165° C. in the direction orthogonal to two sides of the optically laminated body as the fixed ends in the in-plane direction. The obtained optically anisotropic film was of Re¹=105 nm, and Nz¹=1.50.

### (2) Production of the Retardation Film

Next, a retardation layer forming coating solution was obtained by dissolving a liquid crystal mixture containing the liquid crystal materials represented by the following formulae (B), (C) and (D), and a photo polymerization initiating agent (IRGACURE 907 produced by Ciba Specialty Chemicals., 5% by mass with respect to the liquid crystal mixture) to toluene so as to have a 20% by mass solid component, and further adding a leveling agent. Then, the retardation layer forming coating solution was applied onto the glass substrate with the vertical alignment film formed and then dried at 60° C. for 2 minutes for forming the homeotropic orientation alignment. Furthermore, it was cured by directing UV of 100 mJ/cm² so as to form a retardation layer. The retardation layer formed at the time had the film thickness adjustment so as to have Rth²=−155 nm.

Then, a retardation film was produced by peeling off the retardation layer from the glass substrate and attaching the same onto the optically anisotropic layer of the optically anisotropic film via an adhesive.

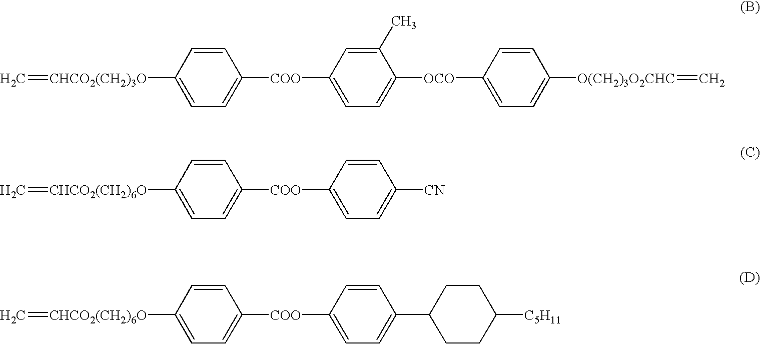

### 2. Example 2

### (1) Production of the Optically Anisotropic Film

An optically anisotropic film was produced in the same manner as in the example 1 except that an optically anisotropic layer forming coating solution was prepared by dissolving a photo polymerizable liquid crystal represented by the following formula (E) (number of the carbon atoms in the alkyl chain: 6) in cyclohexanone by 20% by mass, and further adding a photo polymerization initiating agent by 4% by mass with respect to the solid component. The obtained optically anisotropic film was of Re¹=110 nm, Nz¹=1.48.

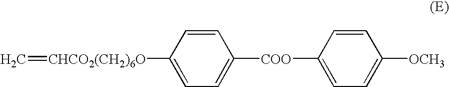

### (2) Production of the Retardation Film

Next, a retardation layer forming coating solution was obtained by dissolving a liquid crystal mixture containing 50% by mass of the side chain type polymer represented by the following formula (F) and 50% by mass of the photo polymerizable liquid crystal represented by the formula (E), and a photo polymerization initiating agent (IRGACURE 907 produced by Ciba Specialty Chemicals., 5% by mass with respect to the photo polymerizable compound) to toluene so as to have a 20% by mass solid component, and further adding a leveling agent. The retardation layer forming coating solution was applied onto the optically anisotropic layer, then dried at 100° C. for 1 minute and cooling down as it is to the room temperature for forming the homeotropic orientation. Furthermore, it was cured by UV of 100 mJ/cm² so as to produce a retardation film. The retardation layer at the time had the film thickness adjustment so as to have Rth²=−155 nm.

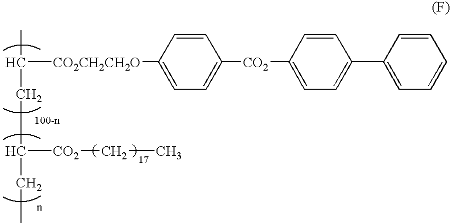

### 3. Example 3

An optically anisotropic film was produced in the same manner as in the example 1 except that an optically anisotropic layer forming coating solution was prepared by dissolving 66.7% by mass of the photo polymerizable liquid crystal represented by the formula (A) and 33.3% by mass of the photo polymerizable liquid crystal represented by the following formula (G) (number of the carbon atoms in the alkyl chain: 4) in cyclohexanone by 10% by mass, and further adding a photo polymerization initiating agent by 4% by mass with respect to the solid component. The obtained optically anisotropic film had Re¹=90 nm, and Nz¹=1.68. Moreover, a retardation film was produced in the same manner as in the example 1 except that the film thickness of the retardation layer was adjusted to Rth²=−200 nm.

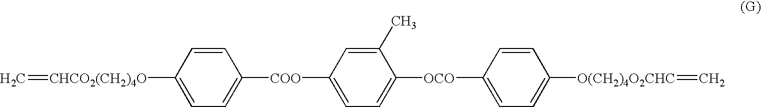

### 4. Example 4

After obtaining an optically laminated body in the same manner as in the example 1, a retardation layer was produced on the optically laminated body coating film surface with the film thickness adjusted to Rth²=−200 nm using the retardation layer forming coating solution produced in the example 2.

Then, a retardation film was produced in the same manner as in the example 1 by the uniaxial drawing of the optically laminated body with the retardation layer formed with a drawing experiment machine so as to have the drawing magnification of 1.2 times while heating at 165° C. in the direction orthogonal to two sides of the optically laminated body as the fixed ends in the in-plane direction. The obtained retardation film was of Re (=Re¹+Re²)=110 nm, and Nz=0.13.

### 5. Example 5

After obtaining the optically anisotropic film of the example 2, a retardation layer was obtained by applying the retardation layer forming coating solution of the example 2 on the plane opposite to the surface with the optically anisotropic layer formed, drying at 100° C. for 1 minute and cooling down as it is to the room temperature for forming the homeotropic orientation. Furthermore, it was cured by UV of 100 mJ/cm² so as to produce a retardation film. The retardation layer at the time had the film thickness adjustment so as to have Rth²=−200 nm.

### 6. Comparative Example 1

An optically anisotropic film was produced in the same manner as in the example 1 except that a liquid crystal mixture with the photo polymerizable liquid crystal compounds represented by the following formulae (H) and (I) (number of the carbon atoms in the alkyl chain: 0) was used as a polymerizable liquid crystal compound. The obtained optically anisotropic film was of Re¹=18 nm, Nz¹=3.92.

Moreover, a retardation film was produced in the same manner as in the example 1 except that the film thickness of the retardation layer was adjusted to Rth²=−200 nm.

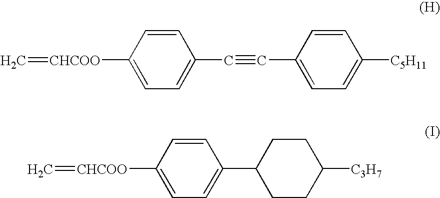

### 7. Comparative Example 2

An optically anisotropic film was produced in the same manner as in the example 1 except that an optically anisotropic layer forming coating solution was adjusted in the same manner as in the example 1 using a photo polymerizable liquid crystal compound represented by the following formula (J) (number of the carbon atoms in the alkyl chain: 2). The obtained optically anisotropic film was of Re¹=28 nm, Nz¹=3.27.

Moreover, a retardation film was produced in the same manner as in the example 1 except that the film thickness of the retardation layer was adjusted to Rth²=−150 nm.

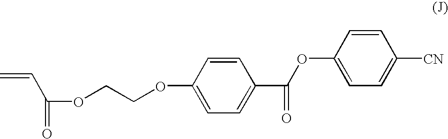

### 8. Evaluation

The in-plane retardation Re¹ and Nz¹, the out-of-plane direction retardation Rth² of the retardation layer, and Nz factor of the retardation film were evaluated as to the optically anisotropic films produced in the examples 1 to 5 and comparative examples 1 to 2. The in-plane retardation, out-of-plane direction retardation and Nz factor were measured using the automatic birefringence measuring device KOBRA.

Furthermore, as to the leaked light evaluation, a liquid crystal display was produced by the following procedure for carrying out the measurement using EZ contrast (produced by ELDIM). The evaluation results are shown in the table 1.

### (1) Production of the Polarizing Plate

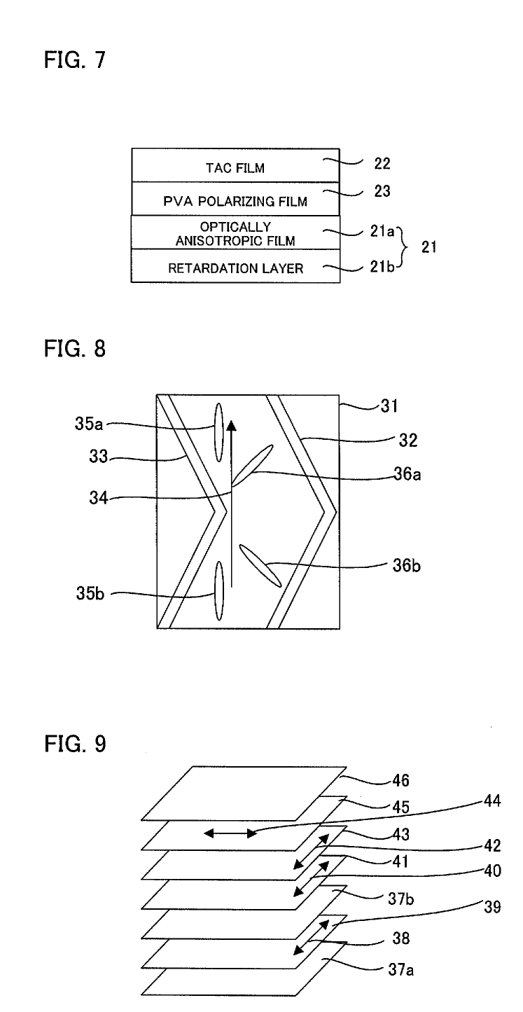

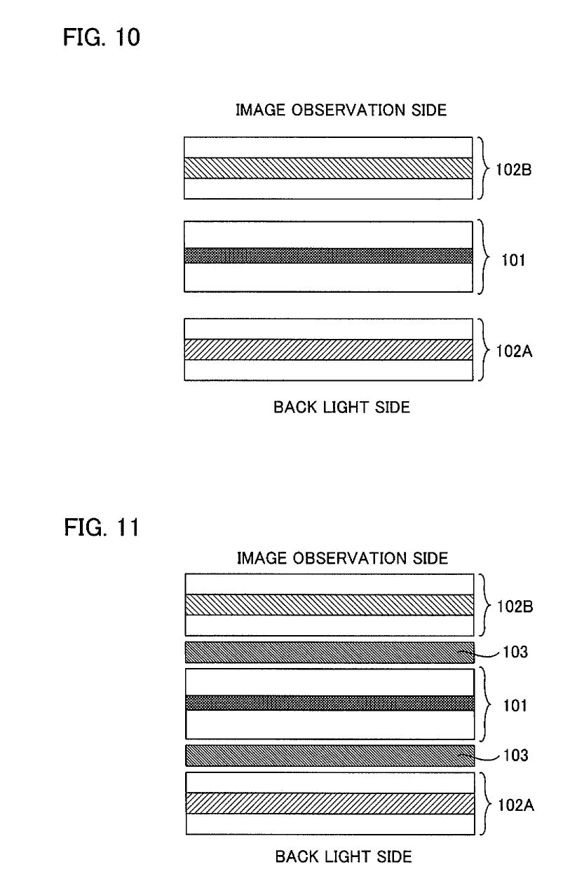

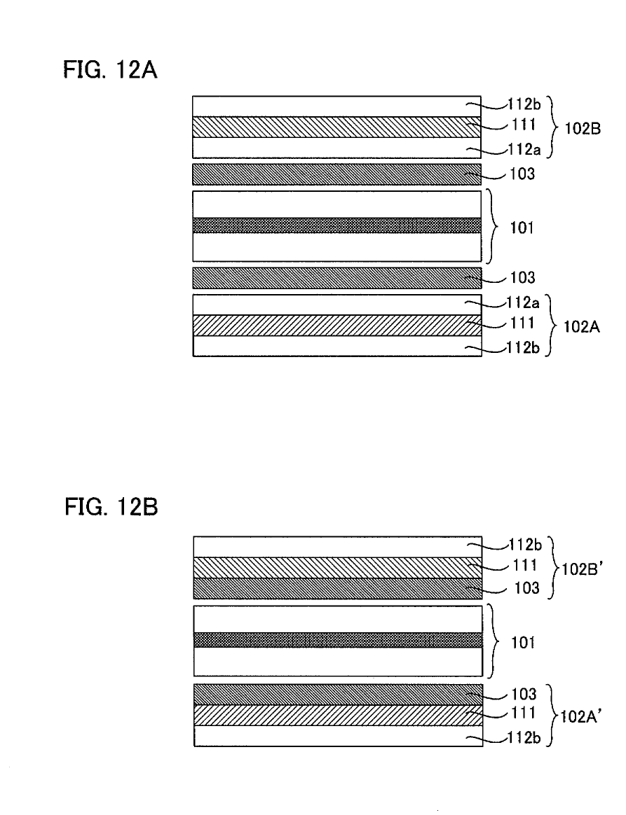

As shown in FIG. 7, a TAC film 22 with a saponification process applied (product name: TF80UL, produced by Fuji Photo Film Corp.) was attached on one side surface of a polarizing film 23 made of polyvinyl alcohol, and the TAC film 22 and a retardation film 21 were attached with a polyvinyl alcohol based adhesive such that the surface opposite to the retardation layer 21b of the retardation film 21 with the saponification process applied is on the other side of the polarizing film 23 with the slow axis of the optically anisotropic film 21a disposed orthogonal to the absorption axis of the polarizing film 23.

### (2) Production of the IPS Cell

Next, as shown in FIG. 8, with electrodes installed with the inter-electrode distance of 20 μm on a sheet of a glass substrate and a polyimide alignment film provided thereon, a rubbing process was carried out. With a polyimide alignment film provided on one side surface of another glass substrate, a rubbing process was carried out in the same manner. The two glass substrates were superimposed and attached with the alignment films facing with each other with a 3.5 μm cell gap d and the rubbing directions of the two glass substrates provided parallel with each other. Then, a nematic liquid crystal composition with a refractive index anisotropic properties (Δn) of 0.0885 and a dielectric anisotropic properties (Δε) of plus 4.5 was sealed there between. The Δn·d value of the liquid crystal layer was 310 nm.

In FIG. 8, reference numeral 31 denotes the liquid crystal element pixel area, 32 denotes the pixel electrode, 33 denotes the display electrode, 34 denotes the rubbing direction, 35a and 35b denote the liquid crystal director at the time of the black display, and 36a and 36b denote the liquid crystal director at the time of the white display.

### (3) Production of the Liquid Crystal Display

A liquid crystal display was produced with the layer configuration as shown in FIG. 9. In FIG. 9, reference numeral 37a denotes the TAC film, 38 denotes the absorption axis of the polarizing film, 39 denotes the polarizing film, 40 denotes the slow axis direction in the liquid crystal in the IPS cell at the time of the black display, 41 denotes the IPS cell, 42 denotes the slow axis of the optically anisotropic film, 43 denotes the retardation film, 44 denotes the absorption axis of the polarizing film, 45 denotes the polarizing film, 37b denotes the isotropic film (Re=0 nm, Rth<10 nm), and 46 denotes the TAC film.

TABLE 1

| | Optically | | Retardation | Retardation | | Leaked |
|---|---|---|---|---|---|---|
| | anisotropic film | | layer | film | | light |
| | Re¹ (nm) | Nz¹ | Rth² (nm) | Re (nm) | Nz | (%) |
| Example 1 | 105 | 1.5 | −155 | — | 0.07 | 0.05 |
| Example 2 | 110 | 1.48 | −155 | — | 0.1 | 0.06 |
| Example 3 | 90 | 1.68 | −200 | — | −0.22 | 0.14 |
| Example 4 | — | — | −200 | 110 | 0.13 | 0.07 |
| Example 5 | 110 | 1.48 | −200 | — | −0.34 | 0.10 |
| Comparative | 10.6 | 3.92 | −150 | — | −8.48 | 3.31 |
| Example 1 | | | | | | |
| Comparative | 28.1 | 3.27 | −150 | — | −1.73 | 1.83 |
| Example 2 | | | | | | |

Next, this embodiment will be explained further specifically with reference to the examples.

### 9. Example 6

### (1) Production of the Optically Anisotropic Film

An optically anisotropic material represented by the formula (A) was dissolved in cyclohexanone by 20% by mass and applied to the surface of a transparent substrate comprising a TAC film (product name: TF80UL produced by FUJIFILM Corporation) by bar coating so as to have the coating amount after drying of 2.5 g/m².

Then, the optically anisotropic material was fixed by directing the ultraviolet ray to the coating surface after eliminating the solvent by heating at 50° C. for 4 minutes.

Next, an optically anisotropic film was produced by drawing in the in-plane direction with a drawing experiment machine so as to have the drawing magnification of 1.15 times while heating at 160° C. The obtained optically anisotropic film was of Re¹=110 nm, and Nz¹=1.50.

### (2) Production of the Retardation Film

Next, a retardation layer forming coating solution was obtained by dissolving a liquid crystal mixture containing 50% by mass of the side chain type polymer represented by the formula (F) and 50% by mass of the polymerizable liquid crystal represented by the formula (G), and a photo polymerization initiating agent (IRGACURE 907 produced by Ciba Specialty Chemicals., 5% by mass with respect to the liquid crystal mixture) to toluene solution so as to have a 20% by mass solid component, and further adding a leveling agent. A retardation layer was obtained by applying the retardation layer forming coating solution onto the optically anisotropic layer, then dried at 100° C. for 1 minute and cooling down as it is to the room temperature for forming the homeotropic orientation. Furthermore, it was cured by UV of 100 mJ/cm² so as to produce a retardation film. The retardation layer at the time had the film thickness adjustment so as to have Rth²=−155 nm.

### 10. Example 7

A retardation film was produced in the same manner as in the example 6 except that the film thickness was adjusted so as to have Rth²=−145 nm of the retardation layer.

### 11. Example 8

A retardation film was produced in the same manner as in the example 6 except that the film thickness was adjusted so as to have Rth²=−135 nm of the retardation layer.

### 12. Example 9

An optically anisotropic film was produced in the same manner as in the example 6 except that the coating amount after drying of the optically anisotropic material was 2.8 g/m². At the time, the optically anisotropic film was of Re¹=115 nm, and Nz¹=1.6. Moreover, a retardation layer with the homeotropic orientation was produced in the same manner as in the example 1. At the time, the film thickness was adjusted so as to have Rth²=−185 nm of the retardation layer.

### 13. Example 10

### (1) Production of the Optically Anisotropic Film

An optically anisotropic material prepared by mixing the polymerizable liquid crystal materials represented by the following formulae (K) and (L) by 1:1 was dissolved in cyclohexanone by 20% by mass and applied to the surface of a transparent substrate comprising a TAC film (product name: TF80UL produced by FUJIFILM Corporation) by bar coating so as to have the coating amount after drying of 3.0 g/m². Then, after eliminating the solvent by heating at 50° C. for 4 minutes, the optically anisotropic material was fixed by directing the ultraviolet ray to the coating surface.

Then, an optically anisotropic film was produced by drawing in the in-plane direction while heating at 160° C. so as to have the drawing magnification of 1.15 times by the drawing experiment device. At the time, the optically anisotropic film was of Re¹=90 nm and Na¹=2.0.

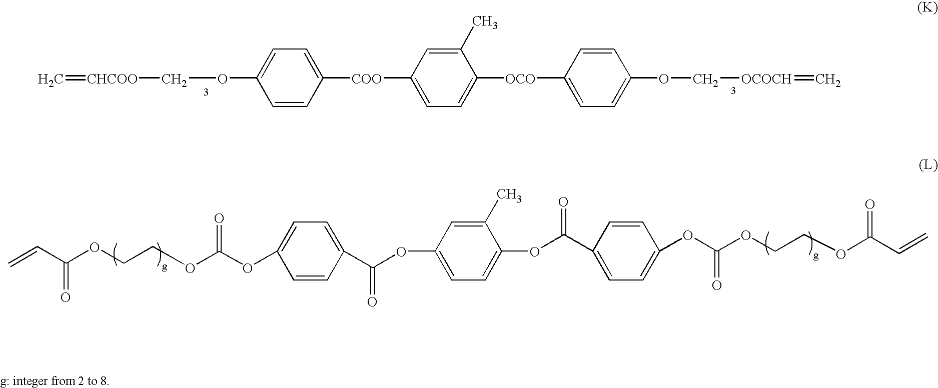

g: integer from 2 to 8.

### (2) Production of the Retardation Film

Next, a retardation layer forming coating solution was obtained by dissolving an optically anisotropic material containing the liquid crystal materials represented by the formulae (B), (C) and (D), and a photopolymerization initiating agent (IRGACURE 907 produced by Ciba Specialty Chemicals., 5% by mass with respect to the optically anisotropic material) to toluene solution so as to have a 20% by mass solid component, and further adding a leveling agent. Then, the retardation layer forming coating solution was applied onto the glass substrate with the vertical alignment film formed, dried at 60° C. for 2 minutes for forming the homeotropic orientation alignment, and cured by directing UV of 100 mJ/cm². At the time, the retardation layer had the film thickness adjustment so as to have Rth²=−195 nm.

Then, a retardation film was produced by peeling off the retardation layer from the glass substrate and attaching the same onto the optically anisotropic layer of the optically anisotropic film disclosed in the example 5 via an adhesive.

### 14. Example 11

An optically anisotropic film was produced in the same manner as in the example 10 except that the coating amount after drying of the optically anisotropic material was 3.3 g/m². At the time, the optically anisotropic film was of Re¹=80 nm, Nz¹=2.5. Moreover, a retardation layer with the homeotropic orientation was produced in the same manner as in the example 10. At the time, the film thickness of the retardation layer was adjusted to Rth²=−225 nm.

### 15. Example 12

An optically anisotropic film was produced in the same manner as in the example 10 except that the coating amount after drying of the optically anisotropic material was 3.6 g/m². At the time, the optically anisotropic film was of Re¹=75 nm, Nz¹=2.9. Moreover, a retardation layer with the homeotropic orientation was produced in the same manner as in the example 10. At the time, the film thickness of the retardation layer was adjusted to Rth²=−245 nm.

### 16. Example 13

A retardation film was produced in the same manner as in the example 6 except that the film thickness was adjusted so as to have Rth²=−125 nm of the retardation layer.

### 17. Example 14

A retardation film was produced in the same manner as in the example 6 except that the film thickness was adjusted so as to have Rth²=−115 nm of the retardation layer.

### 18. Example 15

A retardation film was produced by forming a retardation layer in the same manner as in the example 1 on the side with no optically anisotropic layer of the optically anisotropic film produced in the example 1 formed. At the time, the film thickness was adjusted so as to have the retardation layer of Rth²=−130 nm.

### 19. Comparative Example 3

A retardation film was produced in the same manner as in the example 12 except that the film thickness was adjusted so as to have Rth²=−260 nm of the retardation layer.

### 20. Comparative Example 4

A retardation film was produced in the same manner as in the example 12 except that the film thickness was adjusted so as to have Rth²=−270 nm of the retardation layer.

### 21. Comparative Example 5

An optically anisotropic film was produced in the same manner as in the example 10 except that the coating amount after drying of the optically anisotropic material was 1.5 g/m². At the time, the optically anisotropic film was of Re¹=40 nm, Nz¹=2.0. Moreover, a retardation layer with the homeotropic orientation was produced in the same manner as in the example 10. At the time, the film thickness of the retardation layer was adjusted to Rth²=−70 nm.

### 22. Comparative Example 6

A retardation film was produced in the same manner as in the comparative example 5 except that the film thickness was adjusted so as to have Rth²=−80 nm of the retardation layer.

### 23. Comparative Example 7

An optically anisotropic film was produced in the same manner as in the example 6 except that the coating amount after drying of the optically anisotropic material was 4.0 g/m². At the time, the optically anisotropic film was of Re¹=180 nm, Nz¹=2.0. Moreover, a retardation layer with the homeotropic orientation was produced in the same manner as in the example 6. At the time, the film thickness of the retardation layer was adjusted to Rth²=−370 nm.

### 24. Comparative Example 8

A retardation film was produced in the same manner as in the example 6 except that the film thickness was adjusted so as to have Rth²=−105 nm of the retardation layer.

### 25. Evaluation

The in-plane retardation Re¹ and Nz¹, the out-of-plane direction retardation Rth² of the retardation layer, and Nz factor of the retardation film were evaluated by the method as to the optically anisotropic films produced in the examples 6 to 15 and comparative examples 3 to 8. The in-plane retardation, out-of-plane direction retardation and Nz¹ were measured using the automatic birefringence measuring device KOBRA. The Nz factor of the retardation film was calculated by the above-mentioned formula.

Moreover, as to the leaked light evaluation, a liquid crystal display was produced by the following procedure for measuring the leaked light in the left oblique 60 degree direction of the produced liquid crystal display using EZ contrast (produced by ELDIM).

The evaluation results are shown in the table 2. As shown in the table 2, preferable viewing angle characteristics were obtained with little leaked light in the examples 6 to 15, however, the viewing angle characteristics were drastically lower than those of the examples 6 to 15 with a large amount of leaked light in the comparative examples 3 to 8.

TABLE 2

| | Optically | | Retardation | Retardation | Leaked |
|---|---|---|---|---|---|
| | anisotropic film | | layer | film | light |
| | Re¹ (nm) | Nz¹ | Rth² (nm) | Nz | (%) |
| Example 6 | 110 | 1.5 | −155 | 0.09 | 0.05 |
| Example 7 | 110 | 1.5 | −145 | 0.18 | 0.07 |
| Example 8 | 110 | 1.5 | −135 | 0.27 | 0.10 |
| Example 9 | 115 | 1.6 | −185 | −0.01 | 0.11 |
| Example 10 | 90 | 2.0 | −195 | −0.17 | 0.14 |
| Example 11 | 80 | 2.5 | −225 | −0.31 | 0.16 |
| Example 12 | 75 | 2.9 | −245 | −0.37 | 0.20 |
| Example 13 | 110 | 1.5 | −125 | 0.36 | 0.45 |
| Example 14 | 110 | 1.5 | −115 | 0.45 | 0.60 |
| Example 15 | 110 | 1.5 | −130 | 0.32 | 0.40 |
| Comparative | 75 | 2.9 | −260 | −0.57 | 0.48 |
| Example 3 | | | | | |
| Comparative | 75 | 2.9 | −270 | −0.70 | 0.71 |
| Example 4 | | | | | |
| Comparative | 40 | 2.0 | −70 | 0.25 | 2.02 |
| Example 5 | | | | | |
| Comparative | 40 | 2.0 | −80 | 0.00 | 2.52 |
| Example 6 | | | | | |
| Comparative | 180 | 2.0 | −370 | −0.06 | 3.18 |
| Example 7 | | | | | |
| Comparative | 110 | 1.5 | −105 | 0.55 | 0.75 |
| Example 8 | | | | | |

Furthermore, the contrast ratio of the produced liquid crystal display and the color shift visual conception at the dark and bright places were evaluated according to the following method.

Measuring Method for the Contrast Ratio of the Liquid Crystal Display

With a white image and a black image displayed on the liquid crystal display in a dark room, the Y value of the XYZ color system was measured for the total direction (0° to 360°) of the display image in the polar angle 80° direction using product name “EZ Contrast 160” produced by ELDIM. Then, from the Y value in the white image (Yw) and the Y value in the black image (Yb), a contrast contour picture was produced by the monochrome graduation by calculating the total direction contrast ratio “Yw/Yb”. The polar angle 80° denotes the direction inclined to 80° angle with the premise that the front direction of the display image is 0°.

Color Shift Visual Conception Evaluation in the Dark and Bright Places

Visual evaluation was carried out by in what way the black image is viewed from the polar angle 60° direction and the 45° azimuth direction with the black image displayed on the liquid crystal display in the dark and bright places. Here, the 45° azimuth direction represents the 45° direction with the premise that the polarizing plate absorption axis on the observer side is 0° and the polarizing plate absorption axis on the backlight side is 90°. Moreover, the bright place is about 200 luxes in the case of switching on a fluorescent light in the ordinary household.

The evaluation results are shown in the following table 3.

TABLE 3

Color shift

| | Contrast ratio | Dark place | Bright place |
|---|---|---|---|
| Example 6 | >25 | Blue | Black |
| Example 7 | >30 | Blue | Black |
| Example 8 | >30 | Purple | Black |
| Example 9 | >25 | Blue | Blue |
| Example 10 | >25 | Blue | Blue |
| Example 11 | >25 | Blue | Blue |
| Example 12 | >25 | Blue | Blue |
| Example 13 | >20 | Red | Black |
| Example 14 | >20 | Red | Black |
| Example 15 | >25 | Purple | Black |
| Comparative | <10 | Void | Void |
| Example 3 | | | |
| Comparative | <10 | Void | Void |
| Example 4 | | | |
| Comparative | <10 | Void | Void |
| Example 5 | | | |
| Comparative | <10 | Void | Void |
| Example 6 | | | |
| Comparative | <10 | Void | Void |
| Example 7 | | | |
| Comparative | <10 | Void | Void |
| Example 8 | | | |

1. A retardation film comprising:
an optically anisotropic film having; a transparent substrate made of a cellulose derivative, and an optically anisotropic layer, formed on the transparent substrate, containing the cellulose derivative for comprising the transparent substrate, and a first optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and
a retardation layer, formed on the optically anisotropic film, containing a second optically anisotropic material showing a normal dispersion type wavelength dependency, in which refractive indices nx₂ and ny₂ of optional x and y directions orthogonal with each other in the in-plane direction and a refractive index nz₂ of a thickness direction satisfy the formula of nx₂≦ny₂<nz₂, wherein
the first optically anisotropic material comprises a compound made of a polymerizable rodlike molecule having a structure with a polymerizable functional group and a mesogenic group bonded via an alkyl chain having 4 or more carbon atoms.

2. The retardation film according to claim 1, wherein the compound made of a polymerizable rodlike molecule in the first optically anisotropic material is a monofunctional polymerizable liquid crystal compound having a single polymerizable functional group in the molecule.

3. The retardation film according to claim 1, wherein a wavelength dependency of the in-plane retardation (Re) of the optically anisotropic film is of the normal dispersion type.

4. The retardation film according to claim 1, wherein the cellulose derivative is triacetyl cellulose.

5. A polarizing plate comprising:
the retardation film according to claim 1,
a polarizer formed on the optically anisotropic film of the retardation film, in which the polarizer is formed on a plane opposite to a side with the retardation layer formed, and
a polarizing plate protection film formed on the polarizer.

6. The polarizing plate according to claim 5, wherein the polarizing plate protection film is made of a cycloolefin resin or an acrylic resin.

7. A retardation film comprising:
an optically anisotropic film having; a transparent substrate made of a cellulose derivative, and an optically anisotropic layer, formed on the transparent substrate, containing the cellulose derivative for comprising the transparent substrate, and an optically anisotropic material showing a normal dispersion type wavelength dependency of a retardation, in which a refractive index nx₁ of a slow axis direction in an in-plane direction and a refractive index ny₁ of a fast axis direction in the in-plane direction satisfy the formula of nx₁>ny₁; and
a retardation layer, formed on the optically anisotropic film, containing a liquid crystal material with a homeotropic orientation formed, in which refractive indices nx₂ and ny₂ of optional x and y directions orthogonal with each other in the in-plane direction and a refractive index nz₂ of a thickness direction satisfy the formula of nx₂<ny₂<nz₂, wherein
a Nz factor (Nz) is in a range of −0.5<Nz<0.5, and an in-plane retardation (Re) is in a range of 50 nm<Re<170 nm.

8. The retardation film according to claim 7, wherein an in-plane retardation (Re¹) of the optically anisotropic film is 50 nm<Re¹<170 nm, and a Nz factor (Nz¹) is in a range of 1.0<Nz<3.0.

9. The retardation film according to claim 7, wherein a retardation in the out-of-plane direction of a retardation layer (Rth²) is in a range of −270 nm<Rth²<−50 nm.

10. The retardation film according to claim 7, wherein the cellulose derivative is triacetyl cellulose.

11. The retardation film according to claim 7, wherein the Nz factor (Nz) is in a range of −0.5<Nz<0.3.

12. The retardation film according to claim 7, wherein the retardation layer is formed on the optically anisotropic layer of the optically anisotropic film.
